(19) United States
(12) Patent Application Publication
(10) Pub. No.: US 2018/0039860 A1
(43) Pub. Date: Feb. 8, 2018

(54) IMAGE PROCESSING APPARATUS AND IMAGE PROCESSING METHOD

(71) Applicant: Kabushiki Kaisha Toshiba, Tokyo (JP)

(72) Inventors: Toshiaki NAKASU, Tokyo (JP); Quoc Viet PHAM, Yokohama (JP); Masayuki MARUYAMA, Tokyo (JP); Tomoyuki SHIBATA, Kawasaki (JP); Osamu YAMAGUCHI, Yokohama (JP)

(73) Assignee: Kabushiki Kaisha Toshiba, Tokyo (JP)

(21) Appl. No.: 15/443,648

(22) Filed: Feb. 27, 2017

(30) Foreign Application Priority Data
Aug. 3, 2016 (JP) 2016-153122

(51) Int. Cl. G06K 9/62; G06K 9/00; G06T 7/254; G06T 7/11; G06T 7/174

(52) U.S. Cl. CPC G06K 9/6226; G06T 7/11; G06T 7/174; G06T 7/254; G06K 9/00778; G06T 2207/10024; G06T 2207/20076; G06T 2207/20224; G06T 2207/30196; G06T 2207/30242

(57) ABSTRACT

An image processing method according to an embodiment includes an image acquisition unit, a calculation unit, a region acquisition unit and an estimation unit. The image acquisition unit acquires a target image. The calculation unit calculates a density distribution of targets included in the target image. The estimation unit estimates the density distribution in a first region in the target image based on the density distribution in a surrounding region of the first region in the target image.

### CROSS-REFERENCE TO RELATED APPLICATIONS

This application is based upon and claims the benefit of priority from Japanese Patent Application No. 2016-153122, filed on Aug. 3, 2016; the entire contents of which are incorporated herein by reference.

### FIELD

Embodiments described herein relate generally to an image processing apparatus and an image processing method.

### BACKGROUND

A technology that enables to estimate the density of targets included in an image is disclosed. For example, a technology that enables to estimate the density of persons included in an image is disclosed. A technology that enables to estimate a traffic volume in a period in which the traffic volume is unmeasurable, using a shot image based on a traffic volume in a period in which the traffic volume is measurable is also disclosed.

Conventionally, however, a distribution of the densities of targets in a specific region such as an unmeasurable region in an image cannot be estimated. That is, the density distribution of targets in a specific region in an image is conventionally difficult to estimate.

### BRIEF DESCRIPTION OF THE DRAWINGS

FIG. 1 is a block diagram illustrating a functional configuration of an image processing system according to a first embodiment;

FIGS. 2A to 2C are diagrams illustrating an example of a target image;

FIGS. 3A to 3G are schematic diagrams illustrating a flow of processing for a target image;

FIGS. 4A to 4B are explanatory diagrams illustrating computing of a density ratio of an area;

FIG. 5 is an explanatory diagram of calculation of a density ratio using a weighted average;

FIG. 6 is an explanatory diagram of calculation of a density ratio using a weighted average;

FIGS. 7A to 7C are explanatory diagrams for setting a first region;

FIG. 8 is a schematic diagram illustrating an example of a data configuration of shot-image management information;

FIGS. 9A to 9C are schematic diagrams illustrating an example of a display image;

FIG. 10 is a flowchart illustrating an example of a procedure of image processing;

FIG. 11 is a block diagram illustrating a functional configuration of an image processing system according to a second embodiment;

FIGS. 12A to 12C are explanatory diagrams of estimation of a density distribution of the first region;

FIG. 13 is a flowchart illustrating an example of a procedure of image processing;

FIG. 14 is a block diagram illustrating a functional configuration of an image processing system according to a third embodiment;

FIGS. 15A to 15D are explanatory diagrams of estimation of a density distribution of the first region;

FIG. 16 is a flowchart illustrating an example of a procedure of image processing; and

FIG. 17 is a block diagram illustrating an example of a hardware configuration.

### DETAILED DESCRIPTION

An image processing apparatus according to an embodiment includes an image acquisition unit, a calculation unit

and an estimation unit. The image acquisition unit acquires a target image. The calculation unit calculates a density distribution of targets included in the target image. The estimation unit estimates the density distribution in a first region in the target image based on the density distribution in a surrounding region of the first region in the target image.

Exemplary embodiments of an image processing apparatus and an image processing method will be explained below in detail with reference to the accompanying drawings.

### First Embodiment

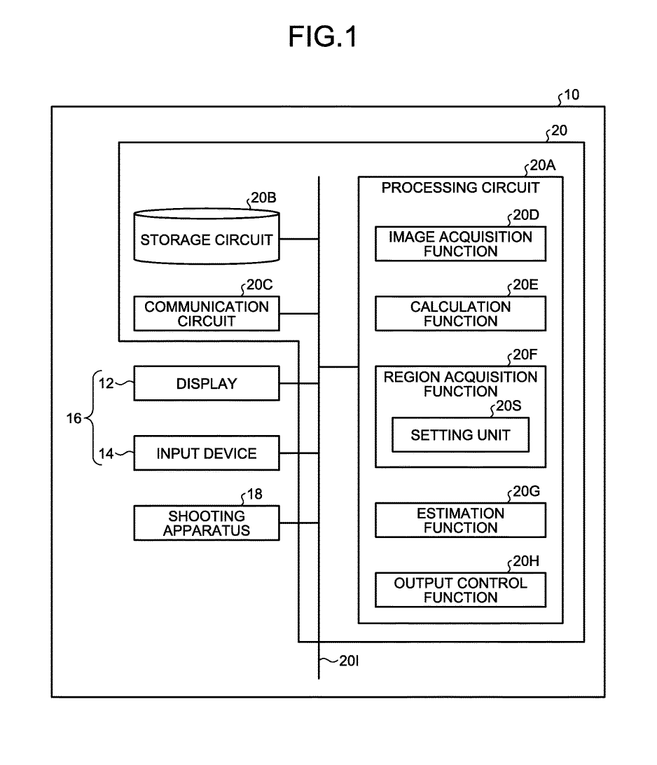

FIG. 1 is a block diagram illustrating a functional configuration of an image processing system 10 according to a first embodiment.

The image processing system 10 includes a UI (User Interface) 16, a shooting apparatus 18, and an image processing apparatus 20. The UI 16 and the shooting apparatus 18 are connected to the image processing apparatus 20 via a bus 201.

The UI 16 has a display function to display various images, and an input function to receive various operation instructions from a user. In the first embodiment, the UI 16 includes a display 12 and an input device 14. The display 12 displays various images. The display 12 is, for example, a CRT (cathode-ray tube) display, a liquid crystal display, an organic EL (electroluminescence) display, or a plasma display. The input device 14 receives various instructions and information inputs from a user. The input device 14 is, for example, a keyboard, a mouse, a switch, or a microphone.

The UI 16 can be a touch panel having the display 12 and the input device 14 configured integrally.

The shooting apparatus 18 performs shooting to obtain an image. In the first embodiment, the shooting apparatus 18 obtains a target image (described in detail later).

The shooting apparatus 18 is, for example, a known digital camera. The shooting apparatus 18 can be placed at a position distant from a processing circuit 20A. For example, the shooting apparatus 18 can be a security camera placed on a road, at a public space, or in a building. The shooting apparatus 18 can be an in-vehicle camera placed on a mobile object such as a vehicle or a camera provided on a mobile terminal. Alternatively, the shooting apparatus 18 can be a camera configured integrally with the image processing apparatus 20. The shooting apparatus 18 can be a wearable camera.

The shooting apparatus 18 is not limited to a visible light camera that captures reflected light of visible light, and can be an infrared camera, a camera that can obtain a depth map, or a camera that performs shooting using a distance sensor, an ultrasonic sensor, or the like. The depth map is an image (also referred to as “distance image”) that defines a distance from the shooting apparatus 18 with respect to each pixel.

That is, a target image used in the first embodiment is a shot image (visible light image) of reflected light of visible light, an infrared image, a depth map, an ultrasonic shot image, or the like. That is, a target image is not limited to a shot image of reflected light of light in a specific wavelength region. In the first embodiment, a case where a target image is a shot image of reflected light of visible light is described as an example.

The image processing apparatus 20 performs image processing using a target image. The target image is an image including targets.

The targets are objects that can be discriminated through an image analysis. A target is, for example, a mobile object or an immobile object. A mobile object is an object capable of moving. A mobile object is, for example, a vehicle (such as a motorcycle, an automobile, or a bicycle), a dolly, an object capable of flying (such as a manned aerial vehicle, or an unmanned aerial vehicle (a drone, for example)), a robot, or a person. An immobile object is an object incapable of moving. A mobile object can be either a living object or a non-living object. A living object is, for example, a person, an animal, a plant, a cell, or a bacterium. A non-living object is, for example, a vehicle, a pollen, or a radial ray.

The target included in the target image can be one type of the examples described above or plural types thereof. That is, the image processing apparatus 20 can perform image processing described below for one type (a person, for example) of the examples listed above, or can perform the image processing for plural types (a person and a vehicle, for example) thereof as the targets included in the target image.

In the first embodiment, a case where the targets are persons is described as an example.

The image processing apparatus 20 is, for example, a dedicated or general-purpose computer. The image processing apparatus 20 is, for example, a PC (personal computer) connected to the shooting apparatus 18, a server that retains and manages images, or a cloud server that performs processing on a cloud.

The image processing apparatus 20 has the processing circuit 20A, a storage circuit 20B, and a communication circuit 20C. That is, the display 12, the input device 14, the shooting apparatus 18, the storage circuit 20B, the communication circuit 20C, and the processing circuit 20A can be connected via the bus 201.

It is sufficient that at least one of the display 12, the input device 14, the shooting apparatus 18, the storage circuit 20B, and the communication circuit 20C is connected to the processing circuit 20A in a wired manner or wirelessly. At least one of the display 12, the input device 14, the shooting apparatus 18, the storage circuit 20B, and the communication circuit 20C can be connected to the processing circuit 20A via a network.

The storage circuit 20B has various kinds of data stored therein. In the first embodiment, the storage circuit 20B has shot-image management information (described in detail later) and the like stored therein.

The storage circuit 20B is, for example, a semiconductor memory element such as a RAM (Random Access Memory) or a flash memory, a hard disk, or an optical disk. The storage circuit 20B can be a storage device provided outside the image processing apparatus 20. Alternatively, the storage circuit 20B can be a storage medium. Specifically, the storage circuit 20B can be a storage medium that has programs or various types of information downloaded via a LAN (Local Area Network) or the Internet and stored or temporarily stored therein. The storage circuit 20B can be constituted of a plurality of storage media.

The communication circuit 20C is an interface that performs input/output of information to/from an external device connected in a wired manner or wirelessly. The communication circuit 20C can be connected to a network to perform communication.

The processing circuit 20A includes an image acquisition function 20D, a calculation function 20E, a region acquisition function 20F, an estimation function 20G, and an output control function 20H. In FIG. 1, functions related to the first embodiment are mainly illustrated. However, functions included in the processing circuit 20A are not limited thereto.

The respective processing functions in the processing circuit 20A are stored in the storage circuit 20B in the form of programs executable by a computer. The processing circuit 20A is a processor that reads programs from the storage circuit 20B and executes the read programs to realize functions corresponding to the respective programs.

The processing circuit 20A in a state having read the respective programs has the functions illustrated in the processing circuit 20A in FIG. 1. In FIG. 1, the image acquisition function 20D, the calculation function 20E, the region acquisition function 20F, the estimation function 20G, and the output control function 20H are assumed to be realized by the single processing circuit 20A.

The processing circuit 20A can be configured by combining plural independent processors for realizing the functions, respectively. In this case, each processor executes a program to realize the corresponding function. A case where each of the processing functions is configured as a program and one processing circuit executes the corresponding program, or a case where a specific function is implemented on a dedicated and independent program execution circuit is also conceivable.

The term “processor” used in the first embodiment and embodiments described later indicates, for example, a CPU (Central Processing Unit), a GPU (Graphical Processing Unit), or a circuit of an ASIC (Application Specific Integrated Circuit), a programmable logic device (an SPLD (Simple Programmable Logic Device), for example), a CPLD (Complex Programmable Logic Device), or an FPGA (Field Programmable Gate Array).

A processor realizes a function by reading and executing a program stored in the storage circuit 20B. Instead of storing a program in the storage circuit 20B, a program can be directly incorporated in a circuit of a processor. In this case, the processor realizes a function by reading and executing the program incorporated in the circuit.

The image acquisition function 20D is an example of an image acquisition unit. The image acquisition function 20D acquires a target image including targets. In the first embodiment, the image acquisition function 20D acquires a target image from the shooting apparatus 18. The image acquisition function 20D can acquire a target image from an external device or the storage circuit 20B.

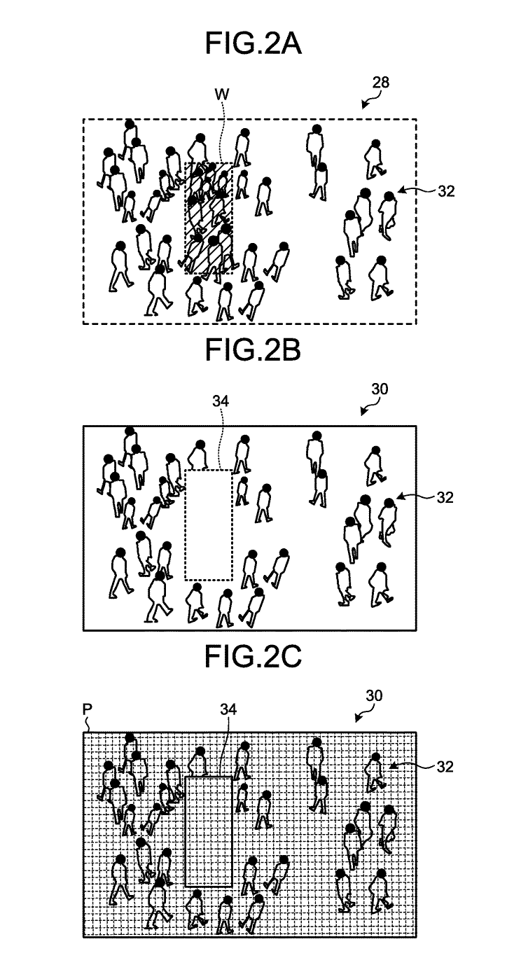

FIGS. 2A to 2C are diagrams illustrating an example of a target image 30. The target image 30 is an image obtained by shooting a shooting region 28 in a real space (see FIGS. 2A and 2B). In the first embodiment, a case where the target image 30 includes persons 32 as targets is described.

The descriptions are continued referring back to FIG. 1. The calculation function 20E is an example of a calculation unit. The calculation function 20E calculates a density distribution of the persons 32 included in the target image 30. A density distribution indicates a distribution of densities in respective regions of the target image 30. In the first embodiment, the calculation function 20E divides the target image 30 into a plurality of areas and calculates the density of persons 32 included in each of the areas. In this way, the calculation function 20E creates the density distribution of the persons 32 included in the target image 30.

FIG. 2C is a schematic diagram illustrating a state of the target image 30 divided into a plurality of areas P. The calculation function 20E divides the target image 30 into the areas P. An arbitrary value can be set as the number of divisions of the target image 30 or the size of the areas P.

For example, the areas P can be respective regions obtained by dividing the target image 30 into M in the vertical direction and N in the horizontal direction to obtain M×N regions. In this case, M and N are integers equal to or larger than 1 and at least one thereof is an integer equal to or larger than 2.

Each of the areas P can be one region being a group of pixels in which at least either the luminances or the colors are similar in pixels constituting the target image 30. Alternatively, the areas P can be regions obtained by dividing the target image 30 according to predetermined environmental attributions. An environmental attribution is a region representing a specific environment in the target image 30. The environmental attribution is, for example, a region representing a pedestrian crossing, a region representing a left lane, a region representing an off-limit area, or a dangerous region.

The areas P can be pixel regions each including a plurality of pixels or can be pixel regions each including one pixel. As the size of the areas P is closer to the size corresponding to one pixel, the image processing apparatus 20 can calculate the density distribution more accurately. Accordingly, it is preferable that the areas P are regions each corresponding to one pixel. However, as described above, the areas P can be regions each including plural pixels.

The calculation function 20E has, for example, a division condition of the areas P previously stored therein. The division condition is, for example, dividing into M in the vertical direction and N in the horizontal direction, dividing according to the luminances and the colors, or dividing according to the environmental attributions.

It is sufficient that the calculation function 20E divides the target image 30 into the areas P under the previously-stored division condition. The division condition can be appropriately changed according to an operation instruction through the input device 14 by a user, or the like.

For example, when the target image 30 is to be divided according to the environmental attributions, the calculation function 20E previously mechanically learns correct data attached with environmental attributions using a feature amount of the target image 30 and generates a discriminator. It is sufficient that the calculation function 20E then divides the target image 30 into a plurality of areas P according to the environmental attributions using the discriminator. For example, when the target image 30 is to be divided according to the environmental attributions representing dangerous regions, it is sufficient that the calculation function 20E previously prepares map data indicating a plurality of dangerous regions and divides the target image 30 into a region corresponding to the dangerous regions of the map data in the target image 30, and a region other than the dangerous regions. Alternatively, the calculation function 20E can divide the target image 30 into a plurality of areas P along a boundary line designated by an operation instruction through the UI 16 by a user.

In the first embodiment, a case where the calculation function 20E divides the target image 30 into M in the vertical direction and N in the horizontal direction is described as an example.

With respect to each of the areas P in the target image 30, the calculation function 20E calculates the density of targets included in the corresponding area P. In the first embodiment, the calculation function 20E calculates the density of persons 32 included in each of the areas P. The calculation function 20E thus calculates the density distribution of the persons 32 included in the target image 30.

For example, the following method can be used to calculate the density of persons 32 included in each of the areas P.

For example, the calculation function 20E counts persons 32 in each of the areas P by a known method. When a part of the body of a person 32 is located in an area P, it is sufficient that a result obtained by dividing the area of the part of the person 32 located in the relevant area P by the area of the person 32 is regarded as the number of the person 32. For example, when 50% of the body of a person 32 is located in the area P, the person 32 can be counted as 0.5 persons.

It is sufficient that the calculation function 20E then calculates a value by dividing the number of the persons 32 located in each of the areas P by the area of the relevant area P as the density of the persons 32 in the area P. Alternatively, the calculation function 20E can calculate a value by dividing the number of the persons 32 included in each of the areas P by the number of pixels constituting the relevant area P as the density of the persons 32 in the area P.

The calculation function 20E can calculate a dispersion degree of the persons 32 in each of the areas P as the density of the persons 32 in the relevant area P. For example, the calculation function 20E calculates positions of the persons 32 in each of the areas P with respect to each of small regions (pixels, for example) obtained by further dividing the area P into plural small regions. The calculation function 20E can then calculate the dispersion degree of small regions in which the person 32 is located in each of the areas P as the density of the persons 32 in the relevant area P.

Alternatively, the calculation function 20E can divide each of the areas P into a plurality of small regions and calculate the number of persons 32 included in each of the small regions. The calculation function 20E can then calculate an average value of the numbers of persons 32 included in the relevant area P as the density of the area P.

The calculation function 20E can calculate the density of targets (persons 32 in the first embodiment) included in each of the areas P using a known calculation method. For example, the calculation function 20E detects the number of faces by a known face detection method with respect to each of the areas P. The calculation function 20E then divides the detected number of faces by the number of pixels constituting the area P with respect to each of the areas P. It is sufficient that the calculation function 20E uses a value (a division result) obtained by this division as the density of persons 32 in each of the areas P.

It is assumed that the image acquisition function 20D acquires an image shot by an infrared camera. In this case, the acquired image is likely to have a high pixel value in a person region. In this case, the calculation function 20E divides the number of pixels having a pixel value equal to or higher than a predetermined threshold in each of the areas P by the number of pixels constituting the area P. The calculation function 20E can use a value (a division result) obtained by this division as the density of persons 32 in each of the areas P.

It is assumed that the image acquisition function 20D acquires a distance image (a depth image) shot by a depth camera. In this case, the calculation function 20E divides the number of pixels indicating a predetermined height (80 centimeters to 2 meters, for example) from the ground in each of the areas P by the number of pixels constituting the area P. The calculation function 20E can use a value (a division result) obtained by this division as the density of persons 32 in each of the areas P.

The calculation function 20E can calculate the density of persons 32 included in each of the areas P using other known methods.

It is sufficient that the calculation function 20E calculates the density of persons 32 at least in a region of the target image 30 other than a first region (described in detail later) acquired by the region acquisition function 20F (described later).

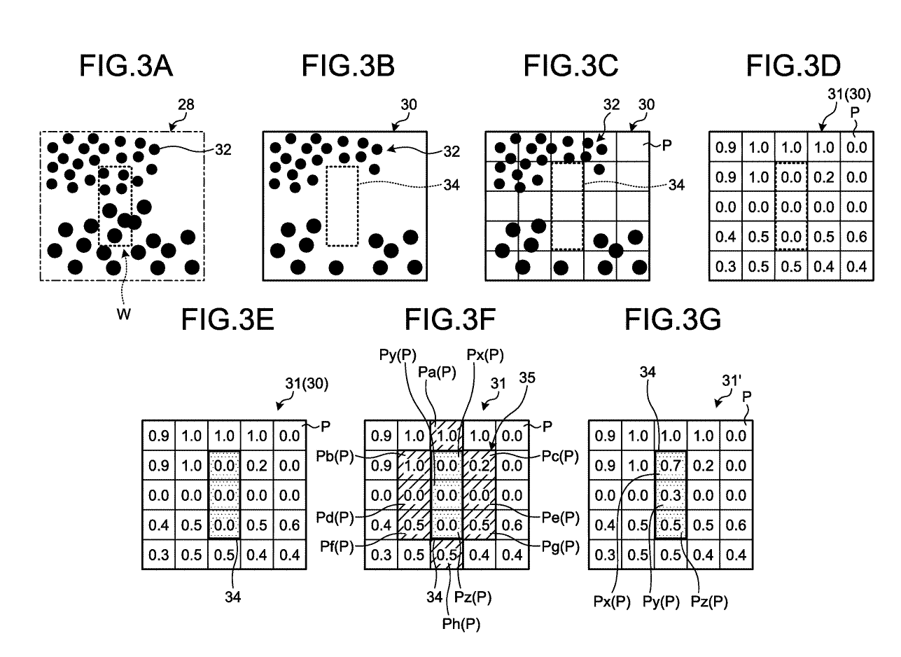

FIG. 3 are schematic diagrams illustrating a flow of processing for a target image 30. For example, it is assumed that the shooting apparatus 18 shoots a shooting region 28 in a real space illustrated in FIG. 3A and acquires a target image 30 illustrated in FIG. 3B. In this case, the calculation function 20E divides the target image 30 into a plurality of areas P. FIG. 3C illustrates a case where the calculation function 20E divides the target image 30 into five in the vertical direction and five in the horizontal direction, that is, into a total of 25 areas P.

The calculation function 20E calculates the density of persons 32 in each of the areas P. FIG. 3D is a diagram illustrating an example of a density distribution 31. As illustrated in FIG. 3D, with respect to each of the areas P, the calculation function 20E calculates the density of persons 32 included in the area P. In this way, the calculation function 20E obtains the density distribution 31.

The descriptions are continued referring back to FIG. 1. The region acquisition function 20F is an example of a region acquisition unit. The region acquisition function 20F acquires a first region set in the target image 30. The first region is an arbitrary region in the target image 30.

The first region can be set in advance with respect to each shooting scene of the target image 30, or the region acquisition function 20F can set the first region.

The shooting scene is information that enables to specify a shooting environment. For example, the shooting scene includes a shooting location, a shooting timing, the weather at the time of shooting, identification information (hereinafter, also “shooting apparatus ID”) of the shooting apparatus 18 that has shot, and contents of an event (a program) held at the shooting location during the shooting.

The shooting timing is, for example, a shooting hour, a shooting period (the season, the shooting time of day (such as the morning, the daytime, or the night), the month when the shooting has been performed, or the day of the week when the shooting has been performed), or the type of an object appearing at a specific timing. The type of an object appearing at a specific timing is, for example, the number of cars of a train arriving in a specific platform. This is because the density distribution of persons 32 on the platform differs according to the number of cars of a train.

When the first region is set in advance, the region acquisition function 20F reads information indicating the first region corresponding to the same shooting scene as (for example, having any one of the shooting apparatus ID, the shooting location, the shooting timing, and the contents of the event matching) that of the target image 30 being a processing target from the storage circuit 20B. In this way, the region acquisition function 20F acquires the first region. The information indicating the first region is, for example, represented by positional coordinates on the target image 30.

The region acquisition function 20F can set the first region depending on the target image 30 being the processing target. In this case, the region acquisition function 20F includes a setting unit 20S.

The setting unit 20S sets the first region in the target image 30 being the processing target. The setting unit 20S can set an arbitrary region in the target image 30 being the processing target as the first region. Alternatively, the setting unit 20S can set a region in the target image 30 being the processing target and designated by an operation instruction through the input device 14 by a user as the first region. In this case, for example, it is sufficient that the user sets the first region by operating the input device 14 to place an icon indicating the first region or draw a line representing an outline of the first region while visually recognizing the display 12.

The setting unit 20S can set a region satisfying a predetermined setting condition in the target image 30 as the first region.

In the first embodiment, a case where the setting unit 20S of the region acquisition function 20F sets a region satisfying a predetermined setting condition in the target image 30 as the first region is described as an example.

As illustrated in FIGS. 2 and 3, there is a case where light of an intensity equal to or higher than a threshold may be reflected when the shooting apparatus 18 shoots the shooting region 28 (see FIGS. 2A and 3A) in a real space. Reflection of light of an intensity equal to or higher than the threshold is, for example, blown-out highlights caused by direct daylight. There may also be a shielding object or the shadow of a shielding object in the shooting region 28 in a real space. The shielding object is an object (a bird or an insect, for example) that temporarily shields the shooting direction of the shooting apparatus 18, an object placed in a shooting angle of view, or the like. When such a shooting region 28 in a real space including reflection of light, a shielding object, the shadow of a shielding object, or the like is shot, the obtained target image 30 may include a region in which correct image recognition of targets such as the persons 32 is difficult to perform.

Specifically, when reflection of light of an intensity equal to or higher than a threshold occurs in a predetermined region W in the shooting region 28 in a real space as illustrated in FIGS. 2A and 3A, there is a case where images of persons 32 that have actually existed are not taken in a region corresponding to the predetermined region W in the target image 30 (see FIGS. 2B and 3B) obtained by shooting the shooting region 28 in the real space.

In such a case, it is difficult to calculate the density of persons 32 in the region corresponding to the predetermined region W in the target image 30 even when an image analysis of the target image 30 is performed by conventional technologies. That is, in the conventional technologies, it is difficult to obtain the density distribution of the persons 32 in the predetermined region W even when the target image 30 obtained by shooting the shooting region 28 in the real space including the predetermined region W is analyzed.

In the first embodiment, the setting unit 20S of the region acquisition function 20F thus sets a region in which an image analysis of the persons 32 in the target image 30 is difficult, as a first region 34.

Specifically, the setting unit 20S sets a region that satisfies at least one of setting conditions described below in the target image 30 being the processing target, as the first region 34.

For example, a setting condition indicates a region having a luminance equal to or lower than a first threshold in the target image 30. In this case, the setting unit 20S sets a region having a luminance equal to or lower than the first threshold in the target image 30 as the first region 34. With this setting, the setting unit 20S can set a region corresponding to a shielding object or the shadow of a shielding object in the target image 30 as the first region 34.

A setting condition can indicate a region having a luminance equal to or higher than a second threshold. In this case, the setting unit 20S sets a region having a luminance equal to or higher than the second threshold in the target image 30 as the first region 34. The second threshold is a value equal to or larger than the first threshold. With this setting, the setting unit 20S can set a region in which light reflection occurs in the target image 30 as the first region 34.

A setting condition can indicate one of the areas P included in the target image 30, in which the density of persons 32 is equal to or lower than a third threshold. In this case, the setting unit 20S sets an area P in the target image 30, in which the density of persons 32 is equal to or lower than the third threshold, as the first region 34. With this setting, the setting unit 20S can set a region in the target image 30, in which it is presumed that images of persons 32 that have actually existed are not taken, as the first region 34.

A setting condition can indicate one of the areas P included in the target image 30, in which the density is lower than that of other areas P around the relevant area P by a fourth threshold or a larger value. In this case, the setting unit 20S sets a region in the target image 30, in which the density is lower than that of other peripheral areas P by the fourth threshold or a larger value as the first region 34. With this setting, the setting unit 20S can set a region in the target image 30, in which it is presumed that images of persons 32 that have actually existed are not taken, as the first region 34.

A setting condition can indicate one of the areas P included in the target image 30, in which a density ratio to other peripheral areas P is equal to or lower than a fifth threshold. In this case, the setting unit 20S sets a region in the target image 30, in which the density ratio to other peripheral areas P is equal to or lower than the fifth threshold, as the first region 34.

With this setting, the setting unit 20S can set a region in which it is presumed that images of persons 32 that have actually existed are not taken, as the first region 34. That is, in this case, a region in which images of persons 32 are not taken due to shielding or an environmental change in a shooting environment where the persons 32 are continuously located can be set as the first region 34.

A setting condition can indicate a region in which the density is equal to or lower than a sixth threshold and the density of persons 32 moving toward other peripheral areas P is equal to or higher than a seventh threshold. In this case, the setting unit 20S sets a region in the target image 30, in which the density is equal to or lower than the sixth threshold and the density of persons 32 moving toward other peripheral areas P is equal to or higher than the seventh threshold, as the first region 34.

With this setting, the setting unit 20S can set a region in the target image 30, in which it is presumed that images of persons 32 that have actually existed are not taken, as the first region 34. That is, in this case, the setting unit 20S can set a region in the target image 30, in which the density is equal to or lower than the sixth threshold and the density of persons 32 moving out of the relevant region is high, as the first region 34.

As for a setting condition, a region in which a difference of the density in the target image 30 being the processing target from the density indicated in other target image 30 shot prior to (immediately before, for example) shooting the processing target image 30 is equal to or larger than an eighth threshold can be set as the first region 34. In this case, the setting unit 20S can set a region that is temporarily shielded during shooting in the target image 30 as the first region 34.

It is sufficient to previously define arbitrary values as the first to eighth thresholds, respectively. It is alternatively possible to appropriately change the first to eighth thresholds by an operation instruction through the input device 14 by a user.

A case where the setting unit 20S sets a region in the target image 30, in which the density ratio to other peripheral areas P is equal to or lower than the fifth threshold as the first region 34 is specifically described.

The setting unit 20S sets the areas P divided by the calculation function 20E in the target image 30 in turn as a density-ratio calculation region being a calculation target for the density ratio. The setting unit 20S then computes the ratio of the density in the density-ratio calculation region to the density in other peripheral areas P.

The other peripheral areas P include at least other areas P located adjacently to the density-ratio calculation region (an area P) in the target image 30.

It is sufficient that the other peripheral areas P are a region including at least other areas P located adjacently to the density-ratio calculation region. For example, the other peripheral areas P can be a region including a plurality of other areas P located continuously in a direction away from a position in contact with the relevant density-ratio calculation region. The other peripheral areas P can be other areas P that surround the circumference of the density-ratio calculation region in 360 degrees or can be other areas P adjacent to a part of the circumference of the density-ratio calculation region.

The setting unit 20S computes the density ratio to the density in the other peripheral areas P with respect to each of the areas P included in the target image 30.

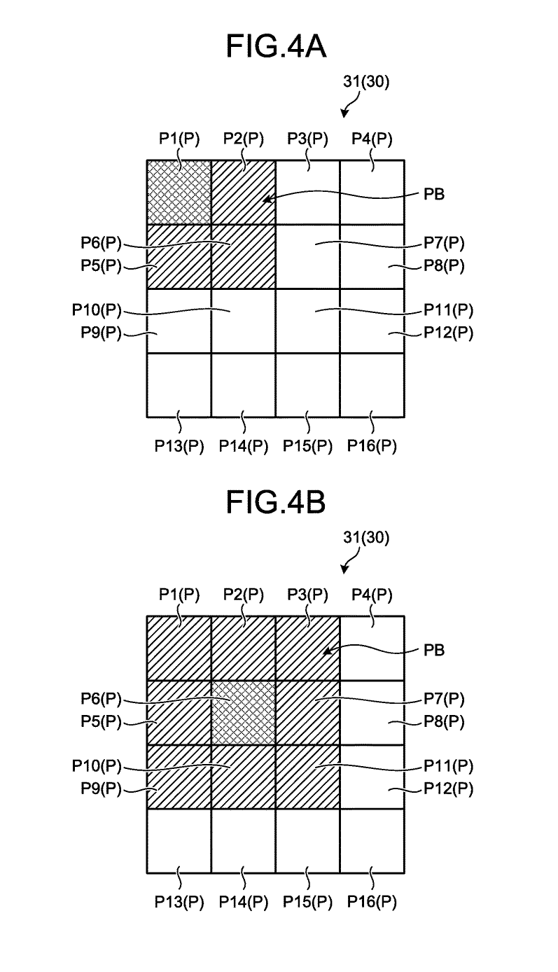

FIGS. 4A to 4B are explanatory diagrams illustrating an example of computing of the density ratio of each of the areas P. The setting unit 20S sets the areas P (areas P1 to P16 in FIG. 4) in the target image 30 in turns as the density-ratio calculation region and computes the density ratio to the density in other peripheral areas P with respect to each of density-ratio calculation regions (the areas P1 to P16). In this way, the setting unit 20S computes the density ratio to the density in other peripheral areas P with respect to each of the areas P included in the target image 30.

FIG. 4A illustrates a state where the setting unit 20S sets the area P1 as the density-ratio calculation region. In this case, other areas P around the area P1 include, for example, the area P2, the area P5, and the area P6 located adjacently to the area P1.

In this case, the setting unit 20S calculates an average value of the densities in the area P2, the area P5, and the area P6 as the density in the other areas P around the area P1. It is sufficient that the setting unit 20S then calculates the density ratio of the density in the area P1 to the density in the other areas P around the area P1 as the density ratio of the area P1.

FIG. 4B illustrates a case where the setting unit 20S sets the area P6 as the density-ratio calculation region. In this case, other areas P around the area P6 include, for example, the areas P1 to P3, the area P5, the area P7, and the areas P9 to P11 located adjacently to the area P6.

The setting unit 20S calculates an average value of the densities in the areas P1 to P3, the area P5, the area P7, and the areas P9 to P11 constituting the other areas P around the area P6, as the density of persons 32 in the other areas P around the area P6. The setting unit 20S then calculates the density ratio of the density of the persons 32 in the area P6 to the density of the persons 32 in the other areas P around the area P6.

The setting unit 20S similarly sets the areas P2 to P5 and the areas P7 to P16 in turn as the density-ratio calculation region and calculates the density ratio to the density of persons 32 in the other peripheral areas P.

The calculation method of the density ratio performed by the setting unit 20S is not limited to the method described above.

For example, the setting unit 20S can calculate the density ratio of each of the areas P using an average value based on a weighted average according to a distance to the density-ratio calculation region from each of other areas P around the density-ratio calculation region.

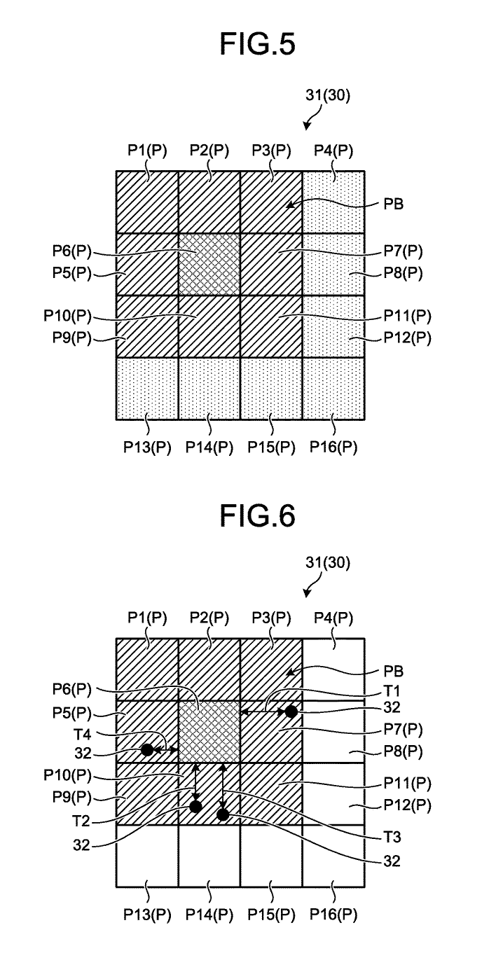

FIG. 5 is an explanatory diagram of calculation of a density ratio using a weighted average.

FIG. 5 illustrates a state where the setting unit 20S sets the area P6 as the density-ratio calculation region. FIG. 5 illustrates a case where other areas P around the area P6 are regions including a plurality of other areas P located in a direction away from a position adjacent to the area P6. That is, in the example illustrated in FIG. 5, the other areas P around the area P6 include other areas P adjacent to the area P6, and other areas P adjacent to the area P6 with the adjacent other areas P interposed therebetween. Specifically, FIG. 5 illustrates a case where the other areas P around the area P6 include the areas P1 to P5 and the areas P7 to P16.

In this case, the setting unit 20S multiplies the density of persons 32 in each of the other areas P around the density-ratio calculation region by a first weighting value m. For example, m is a value larger than 0 and smaller than 1. The first weighting value m is larger in an area P located at a position nearer the set density-ratio calculation region (the area P6 in FIG. 5).

The setting unit 20S has the distances from the density-ratio calculation region and the first weighting value m stored therein in advance in association with each other.

The setting unit 20S multiplies the density of persons 32 in each of the other areas P around the density-ratio calculation region by the first weighting value m corresponding to the distance from the density-ratio calculation region. For example, the setting unit 20S multiplies the density in each of other areas P (the areas P1 to P3, the area P5, the area P7, and the areas P9 to P11) adjacent to the area P6 being the density-ratio calculation region, by the first weighting value m “0.8”. The setting unit 20S multiples the density in each of the area P4, the area P8, the area P12, and the areas P13 to P16 located at a position farther from the area P6 than the areas P described above, by the first weighting value m “0.5”.

In this way, the setting unit 20S calculates a multiplication result by multiplying the density of the persons 32 in each of the other areas P around the density-ratio calculation region by the corresponding first weighting value m.

The setting unit 20S then calculates an average value of the multiplication results calculated for the respective other areas P around the density-ratio calculation region as the density in the other areas P around the density-ratio calculation region.

The setting unit 20S then calculates the ratio of the density in the density-ratio calculation region to the density in the other areas P around the density-ratio calculation region as the density ratio of the relevant density-ratio calculation region. It is sufficient that the setting unit 20S similarly sets the remaining areas P (the areas P1 to P5 and the areas P7 to P16) in turn as the density-ratio calculation region and calculates the relevant density ratio.

As described above, the setting unit 20S can calculate the density ratio using an average value based on the weighted average according to the distance of each of other areas P around the density-ratio calculation region from the density-ratio calculation region.

Alternatively, the setting unit 20S can calculate the density ratio using an average value based on a weighted average according to a distance between a person 32 included in each of the other areas P around the density-ratio calculation region and the density-ratio calculation region.

FIG. 6 is an explanatory diagram of calculation of a density ratio using a weighted average.

FIG. 6 illustrates a state where the setting unit 20S sets the area P6 as the density-ratio calculation region. FIG. 6 illustrates a case where other areas P around the area P6 being the density-ratio calculation region are the areas P1 to P3, the area P5, the area P7, and the areas P9 to P11 adjacent to the area P6.

In this case, the setting unit 20S multiples the density in each of the other areas P around the area P6 being the density-ratio calculation region by a second weighting value n. For example, n is a value larger than 0 and smaller than 1. The second weighting value n is a larger value as the distance between a person 32 included in the other areas P and the density-ratio calculation region (the area P6 in FIG. 6) is smaller.

For example, the setting unit 20S calculates the distance between a person 32 included in each of the other areas P around the density-ratio calculation region and the density-ratio calculation region. For example, it is sufficient that the setting unit 20S calculates the density in each of the areas P and the position of a person 32 in the corresponding area P. It is sufficient that the setting unit 20S then calculates the distance between the person 32 included in each of the other areas P around the density-ratio calculation region and the density-ratio calculation region based on the position of the person 32.

The setting unit 20S calculates a division result obtained by dividing a number “1” by the distance between the person 32 and the density-ratio calculation region as the second weighing value n for the area P including the person 32. Accordingly, a larger second weighing value n is calculated for other area P in which the distance between the person 32 included therein and the density-ratio calculation region is smaller.

There is a case where a plurality of persons 32 are included in one area P. In this case, the setting unit 20S calculates a division result obtained by dividing the number “1” by the distance between a person 32 and the density-ratio calculation region with respect to each of the persons 32 included in the area P. It is sufficient that the setting unit 20S then calculate a total value of the respective division results calculated with respect to the persons 32 included in the same area P as the second weighting value n for the relevant area P. Accordingly, as the number of included persons 32 is larger, a larger second weighting value n is calculated.

It is sufficient that the setting unit 20S calculates a smaller value than a minimum value of the second weighting value n for areas P including a person 32 in the target image 30, as the second weighting value n for an area P including no persons 32.

The setting unit 20S calculates an average value of multiplication results each being obtained by multiplying the density in each of other areas P around the density-ratio calculation region by the corresponding second weighting value n, as the density of the other areas P. That is, the setting unit 20S calculates a total value by summing up the multiplication results each being obtained by multiplying the density in each of the other areas P around the density-ratio calculation region by the corresponding second weighting value n. The setting unit 20S then divides the total value by the number of the other areas P to calculate the average value. The setting unit 20S computes the average value as the density of persons 32 in the other areas P around the density-ratio calculation region.

Furthermore, the setting unit 20S calculates the ratio of the density in an area P (the area P6, for example) set as the density-ratio calculation region to the density in the other areas P around the density-ratio calculation region, as the density ratio of the relevant area P6. It is sufficient that the setting unit 20S similarly sets the other areas P (the areas P1 to P5 and the areas P7 to P16) in turns as the density-ratio calculation region and calculates the density ratio.

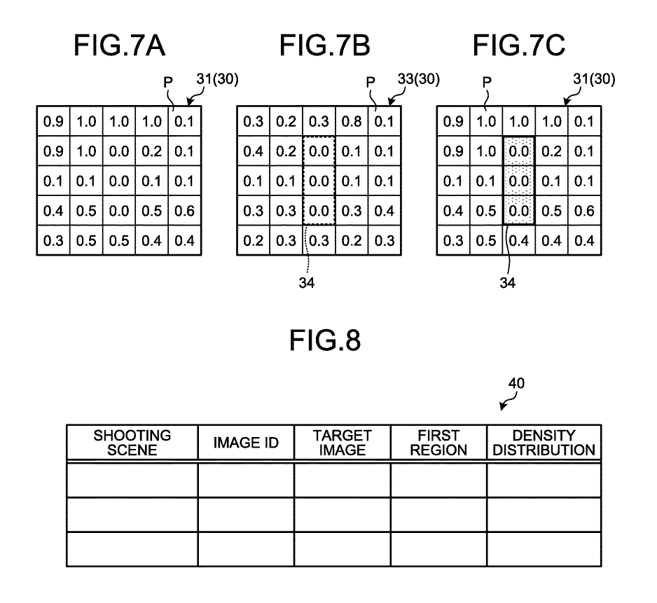

FIGS. 7A to 7C are explanatory diagrams for setting the first region 34 based on the density ratios of the respective areas P. For example, it is assumed that the density distribution of the target image 30 being the processing target is a density distribution 31 illustrated in FIG. 7A. It is assumed that the setting unit 20S calculates the density ratio of each of the areas P to the density in the other peripheral areas P based on the density distribution 31. FIG. 7B is a diagram illustrating an example of a density ratio distribution 33.

In this case, the setting unit 20S sets a region in which the density ratio is equal to or lower than the fifth threshold (0.0, for example) in the density ratio distribution 33 as the first region 34 (see FIG. 7C).

As described above, it is sufficient that the setting unit 20S sets a region that satisfies the predetermined setting condition in the target image 30 as the first region 34, and the setting is not limited to a mode using the density ratio.

Referring back to FIG. 3, the region acquisition function 20F acquires the first region 34 in the target image 30 in this way (see FIG. 3E). That is, as described above, the first region 34 is a region corresponding to the predetermined region W in the shooting region 28 in the real space (see FIGS. 3A to 3C).

The shape of the first region 34 is not limited. It is sufficient that the shape of the first region 34 is a shape indicating a closed region represented by a combination of curved lines and straight lines. The shape of the first region 34 can be, for example, a polygonal shape or a circular shape.

Furthermore, the number of the first regions 34 set in the target image 30 is not limited, and one first region 34 or a plurality of first regions 34 can be set. Adjacent first regions 34 are handled as one continuous first region 34.

The region acquisition function 20F can store information (positional coordinates on the target image 30, for example) indicating the first region 34 in the storage circuit 20B to be associated with the shooting scene of the target image 30.

In this case, the region acquisition function 20F stores shot-image management information 40 illustrated in FIG. 8 in the storage circuit 20B. FIG. 8 is a schematic diagram illustrating an example of a data configuration of the shot-image management information 40. The shot-image management information 40 is a database having information indicating the first region 34 with respect to each shooting scene registered therein. The data format of the shot-image management information 40 is not limited to a database.

In the example illustrated in FIG. 8, the shot-image management information 40 has the shooting scene, the image ID, the target image 30, the information indicating the first region, and the density distribution associated with each other.

The density distribution in the shot-image management information 40 is updated each time the calculation function 20E calculates the density distribution 31 of the persons 32. It is preferable that the density distribution in the first region 34 is updated with a value estimated by the estimation function 20G described later.

When the storage circuit 20B has the shot-image management information 40 stored therein, it is sufficient that the region acquisition function 20F acquires the first region 34 by reading the information indicating the first region 34 and corresponding to a shooting scene that includes at least one same shooting environment as that of the target image 30 being the processing target, from the shot-image management information 40.

A shooting scene that includes at least one same shooting environment as that of the target image 30 being the processing target indicates a shooting scene in which at least one of the shooting location, the shooting timing, the weather at the time of shooting, and the shooting apparatus ID is the same as that of the target image 30 being the processing target.

The descriptions are continued referring back to FIG. 1. The estimation function 20G is an example of an estimation unit. Based on the density distribution of the persons 32 in a region around the first region 34 in the target image 30, the estimation function 20G estimates the density distribution of the first region 34 in the target image 30.

In the first embodiment and following embodiments, the density distribution of the persons 32 is sometimes referred to simply as “density distribution” to simplify the descriptions. Similarly, in the first and following embodiments, the density of the persons 32 is sometimes referred to simply as “density”. That is, in the first and following embodiments, the density and density distribution just indicate the density and density distribution of the persons 32.

The estimation function 20G is described in detail. First, the estimation function 20G sets a surrounding region of the first region 34 in the target image 30. This is described with reference to FIG. 3. For example, the estimation function 20G sets a surrounding region 35 around the first region 34 (see FIG. 3F).

The surrounding region 35 is a region adjacent to the first region 34 in the target image 30. It is sufficient that the surrounding region 35 is a region adjacent to at least a part of the circumference of the first region 34, and the surrounding region 35 is not limited to a region adjoining the entire circumference of the first region 34 in 360 degrees.

Specifically, the surrounding region 35 includes other areas P located around areas P constituting the first region 34 to be adjacent to the first region 34.

It is sufficient that the surrounding region 35 of the first region 34 is a region including at least other areas P located adjacently to the circumference of the first region 34. For example, the surrounding region 35 of the first region 34 can be a region including a plurality of other areas P located continuously in a direction away from a position in contact with the first region 34. It is sufficient that the surrounding region 35 of the first region 34 includes other areas P located to be continuous with the first region 34 and surrounding at least a part of the circumference of the first region 34.

FIG. 3F illustrates a case where the surrounding region 35 of the first region 34 constituted of an area Px, an area Py, and an area Pz is areas Pa to Ph as an example.

Next, the estimation function 20G estimates the density distribution of the first region 34 based on the density distribution of the surrounding region 35.

For example, the estimation function 20G estimates the density distribution of the first region 34 using the average value of densities represented by the density distribution of the surrounding region 35 in the target image 30.

Specifically, the estimation function 20G estimates, with respect to each of the areas P (the area Px, the area Py, and the area Pz in FIG. 3) included in the first region 34, the average value of the densities in other areas P adjacent to the relevant area P in the surrounding region 35 as the density in each of the areas P included in the first region 34.

This is described with reference to FIG. 3F. For example, the estimation function 20G calculates the average value ((1.0+1.0+0.2)/3≈0.7) of the densities in the area Pa, the area Pb, and the area Pc adjacent to the area Px in the first region 34 and included in the surrounding region 35, as the density in the area Px (see FIG. 3G).

The estimation function 20G also calculates the average value ((0.5+0.5+0.5)/3≈0.5) of the densities in the area Pf, the area Pg, and the area Ph adjacent to the area Pz in the first region 34 and included in the surrounding region 35, as the density in the area Pz (see FIG. 3G).

The estimation function 20G then calculates the average value ((0.0+0.0+0.7+0.5)/4≈0.3) of the densities in the area Pd and the area Pe adjacent to the area Py in the first region 34 and included in the surrounding region 35, and the area Px and the area Pz adjacent to the area Py and having the estimated densities, as the density in the area Py (see FIG. 3G).

When the first region 34 is located at an end of the target image 30, areas P included in the first region 34 may include an area P not adjacent to the surrounding region 35. In this case, it is sufficient that the estimation function 20G calculates the density in the area P not adjacent to the surrounding region 35 in the first region 34 assuming that the density in the surrounding region 35 is “0.0”. Alternatively, the estimation function 20G can calculate the density in the area P not adjacent to the surrounding region 35 in the first region 34 using a value obtained through interpolation from the densities in the areas P included in the surrounding region 35.

From the processing described above, the estimation function 20G calculates the density in each of the areas P (the areas Px to Pz) constituting the first region 34. With this calculation, the estimation function 20G estimates the density distribution of the first region 34 (see FIG. 3G). In other words, the estimation function 20G generates a density distribution 31′ including a density distribution of a part of the target image 30 other than the first region 34 and an estimated density distribution in the first region 34 of the target image 30.

The estimation function 20G can estimate the density distribution of the first region 34 using other methods.

For example, the estimation function 20G can estimate the density distribution of the first region 34 by performing polynomial interpolation of the density distribution of the surrounding region 35 in the target image 30. A known method can be used for the polynomial interpolation. Alternatively, the estimation function 20G can estimate the density distribution of the first region 34 by linear interpolation using a linear expression as a polynomial expression.

The estimation function 20G can estimate the density distribution of the first region 34 using a function representing a regression plane or a regression curve. In this case, the estimation function 20G generates a function representing a regression plane or a regression curve that approximates the density distribution of the target image 30 based on the densities in the areas P included in the surrounding region 35 of the target image 30. A known method can be used for generation of the function representing a regression plane or a regression curve. The estimation function 20G can then estimate the density distribution of the first region 34 from the density distribution of the surrounding region 35 in the target image 30 using the generated function.

The descriptions are continued referring back to FIG. 1. The output control function 20H executes control to output information indicating the estimation result of the estimation function 20G.

The estimation result of the estimation function 20G is the density distribution 31′ (see FIG. 3G) including the density distribution of a region (hereinafter, also “second region”) other than the first region 34 in the target image 30, and the density distribution of the first region 34 estimated by the estimation function 20G. The densities in the areas P calculated by the calculation function 20E can be used for the density distribution of the second region.

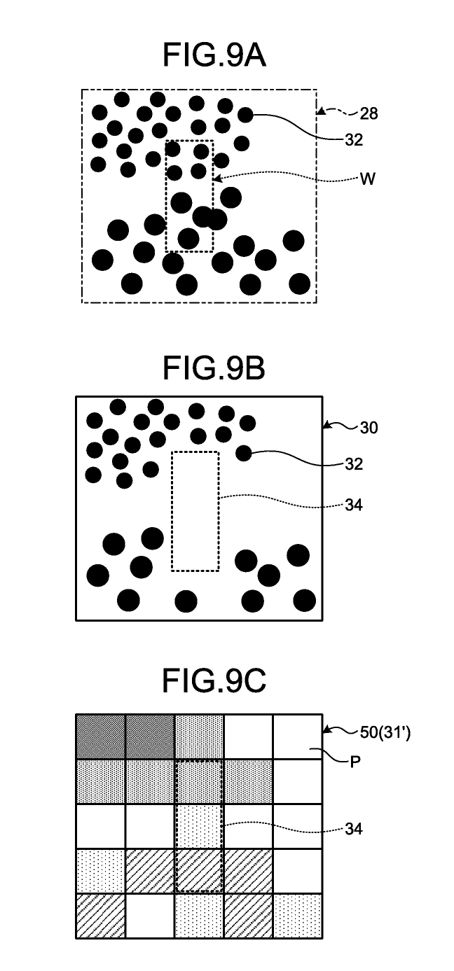

For example, the output control function 20H displays a display image indicating the estimation result of the estimation function 20G on the display 12. FIG. 9 are schematic diagrams illustrating an example of a display image 50. For example, it is assumed that the target image 30 illustrated in FIG. 9B is obtained by shooting a shooting region 28 in a real space illustrated in FIG. 9. It is also assumed that reflection of light equal to or higher than a threshold occurs in a predetermined region W in the shooting region 28 of the real space and that images of persons 32 in the predetermined region W are not taken in the target image 30 (FIG. 9B) obtained by shooting the shooting region 28 in the real space.

Even in this case, in the first embodiment, by setting the predetermined region W as the first region 34, the estimation function 20G estimates the density distribution of persons 32 in the first region 34 based on the surrounding region 35 of the first region 34.

The output control function 20H creates the display image 50 indicating the density distribution 31′. For example, the output control function 20H generates the display image 50 in which the areas P included in the target image 30 are represented by a display mode according to the densities in the corresponding areas P (by colors according to the densities, for example). Accordingly, as illustrated in FIG. 9C, the display image 50 indicating the estimation result of the densities in the first region 34 is displayed on the display 12.

The output control function 20H can output the information indicating the estimation result of the estimation function 20G to an external device via the communication circuit 20C. The output control function 20H can store the information indicating the estimation result of the estimation function 20G in the storage circuit 20B.

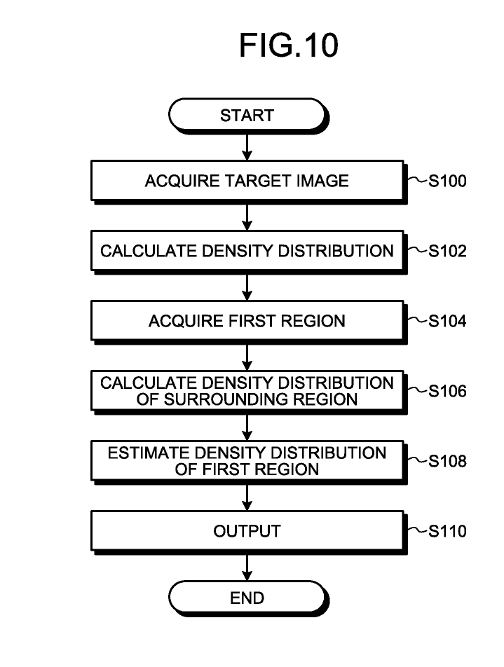

An example of a procedure of image processing performed by the processing circuit 20A of the first embodiment is described next. FIG. 10 is a flowchart illustrating an example of the procedure of the image processing performed by the processing circuit 20A of the first embodiment.

First, the image acquisition function 20D acquires a target image 30 (Step S100). Next, the calculation function 20E calculates the density distribution of persons 32 in the target image 30 acquired at Step S100 (Step S102). In the first embodiment, with respect to each of areas P obtained by dividing the target image 30 acquired at Step S100 into a plurality of areas P, the calculation function 20E calculates the density of persons 32 included in the relevant area P. The calculation function 20E thus calculates the density distribution 31.

Next, the region acquisition function 20F acquires a first region 34 in the target image 30 (Step S104). Subsequently, the estimation function 20G calculates the density distribution of persons 32 in a surrounding region 35 of the first region 34 acquired at Step S104 in the target image 30 acquired at Step S100 (Step S106).

Next, the estimation function 20G estimates the density distribution of persons 32 in the first region 34 acquired at Step S104 based on the density distribution of the surrounding region 35 calculated at Step S106 (Step S108). The output control function 20H then outputs the estimation result obtained at Step S108 (Step S110). The present routine then ends.

As described above, the image processing apparatus 20 of the first embodiment includes the image acquisition function 20D, the calculation function 20E, the region acquisition function 20F, and the estimation function 20G. The image acquisition function 20D acquires a target image 30. The calculation function 20E calculates the density distribution 31 of targets (persons 32) included in the target image 30. The region acquisition function 20F acquires a first region 34 set in the target image 30. The estimation function 20G estimates the density distribution of the first region 34 in the target image 30 based on the density distribution of a surrounding region 35 of the first region 34 in the target image 30.

In this way, in the image processing apparatus 20 of the first embodiment, with respect to the first region 34 in the target image 30, the density distribution of targets (persons 32) in the first region 34 is estimated from the density distribution of targets (persons 32) in the surrounding region 35 around the first region 34.

Accordingly, in the image processing apparatus 20 of the first embodiment, even when the first region 34 is a region in which the persons 32 cannot be measured in the target image 30, the density distribution of the first region 34 can be estimated from the density distribution of the persons 32 in the surrounding region 35 of the first region 34.

Therefore, the image processing apparatus 20 of the first embodiment can estimate the density distribution of targets in a specific region of an image.

In the first embodiment, a case where the processing circuit 20A estimates the density distribution of persons 32 in the first region 34 of the target image 30 has been described as an example.

However, as described above, it is sufficient that the estimation targets of the density distribution are targets and the estimation targets are not limited to the persons 32.

The processing circuit 20A can estimate the density distribution of the first region 34 with respect to each of attributions of targets.

When the targets are the persons 32, the attributions of the targets are the sex, the age, the generation, the direction of the face, and the like. A known image analysis method can be used to distinguish the attributions of the targets from the target image 30.

When the attributions of some of the persons 32 included in the target image 30 are hard to distinguish, it is sufficient that the processing circuit 20A performs the following processing. Specifically, the processing circuit 20A calculates a ratio (a male-to-female ratio, ratios of generations, or the like) of attributions of the persons 32 included in the density distribution, using persons 32 having attributions that can be distinguished among the persons 32 included in the target image 30. It is sufficient that the processing circuit 20A then estimates the attributions of persons 32 having attributions that cannot be distinguished among the persons 32 included in the target image 30 from the calculated ratio.

### Second Embodiment

In a second embodiment, the density distribution of the first region 34 is estimated by a method different from that in the first embodiment.

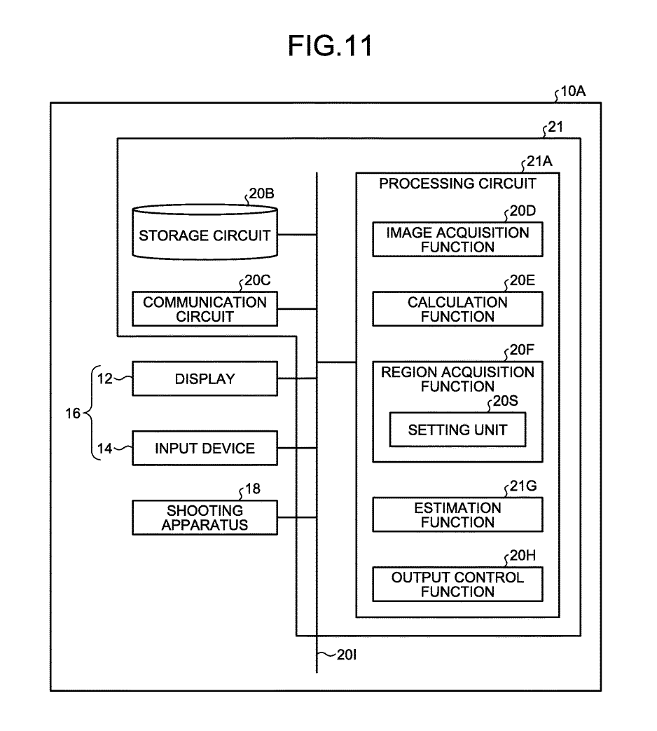

FIG. 11 is a block diagram illustrating a functional configuration of an image processing system 10A according to the second embodiment.

The image processing system 10A includes the UI 16, the shooting apparatus 18, and an image processing apparatus 21. The UI 16 and the shooting apparatus 18 are connected to the image processing apparatus 21 via the bus 201. The image processing system 10A is identical to the image processing system 10 of the first embodiment except that the image processing apparatus 21 is provided instead of the image processing apparatus 20.

The image processing apparatus 21 is, for example, a dedicated or general-purpose computer. The image processing apparatus 21 is, for example, a PC (personal computer) connected to the shooting apparatus 18, a server that retains and manages images, or a cloud server that performs processing on a cloud.

The image processing apparatus 21 has a processing circuit 21A, the storage circuit 20B, and the communication circuit 20C. The image processing apparatus 21 is identical to the image processing apparatus 20 of the first embodiment except that the processing circuit 21A is provided instead of the processing circuit 20A.

The processing circuit 21A has the image acquisition function 20D, the calculation function 20E, the region acquisition function 20F, an estimation function 21G, and the output control function 20H. FIG. 11 mainly illustrates functions related to the second embodiment as an example. However, functions included in the processing circuit 21A are not limited thereto.

The processing circuit 21A is identical to the processing circuit 20A of the first embodiment except that the estimation function 21G is provided instead of the estimation function 20G.

The estimation function 21G estimates the density distribution of the first region 34 in the target image 30 based on density distributions of a first region 34 and a surrounding region 35 in a reference image and the density distribution of the surrounding region 35 in the target image 30.

In the second embodiment, the reference image is an average-density distribution image indicating a distribution of average densities in the target image 30. In the second embodiment, the reference image is an average-density distribution image in which an average value of densities of persons 32 in one shot image or a plurality of shot images shot in a shooting scene corresponding to the target image 30 being an estimation target of the density distribution of the first region 34 is defined with respect to each of areas P.

In other words, in the second embodiment, the reference image is an image in which the average value of the densities of persons 32 in a plurality of other target images 30 other than the target image 30 being a processing target and shot in a shooting scene corresponding to the target image 30 as the processing target is defined with respect to each of the areas P.

The target image 30 being the processing target indicates the target image 30 being an estimation target of the density distribution of the persons 32 in the first region 34.

The shot images (other target images 30) shot in a shooting scene corresponding to the target image 30 being the processing target are other target images 30 where the shooting locations are the same as that of the target image 30 being the processing target and at least one of the shooting timings, the weathers at the time of shooting, and the contents of events (programs) held at the shooting locations during the shooting is different.

The reference image in the second embodiment is an average-density distribution image where the average value of the densities of the persons 32 in these other target images 30 is defined with respect to each of the areas P.

The reference image in the second embodiment can be a reference image obtained by calculating the average density with respect to each of the areas P using target images 30 that are other target images 30 shot at the same shooting location as that of the target image 30 being the processing target and in which images of persons 32 that can be subjected to an image analysis are taken in a region corresponding to the first region 34 in the target image 30 as the processing target.

The reference image in the second embodiment can be a reference image obtained by calculating the average density in the other target images 30 with respect to each of the areas P using the density of persons 32 in a region other than the first region 34, which is set at the time of estimation of the density in each of the other target images 30.

Alternatively, the reference image in the second embodiment can be an average-density distribution image in which the average of the densities of persons 32 in the other target images 30 is defined with respect to each of the areas P using a density distribution obtained after the estimation function 21G, which is described later, estimates the density distribution of the first region 34.

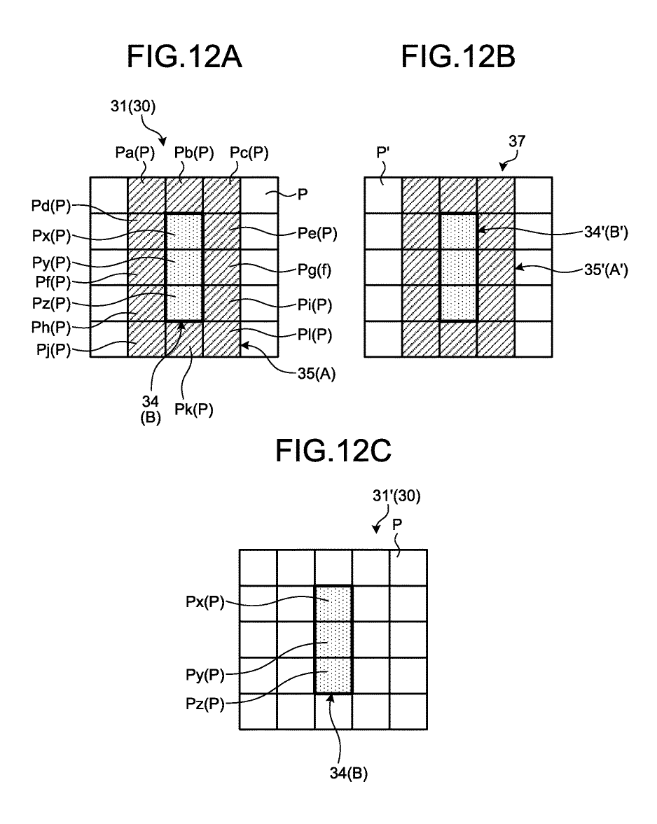

FIG. 12 are explanatory diagrams of estimation of a density distribution of the first region 34 using a reference image 37 in the second embodiment. For example, it is assumed that the calculation function 20E calculates a density distribution 31 from a target image 30 (see FIG. 12A). It is assumed that the region acquisition function 20F then sets a first region 34 in the target image 30 and a surrounding region 35 around the first region 34 (see FIG. 12A). In the example illustrated in FIG. 12A, the first region 34 in the target image 30 includes an area Px, an area Py, and an area Pz. The surrounding region 35 in the target image 30 includes areas Pa to P1.

It is assumed that the estimation function 21G acquires a reference image 37 illustrated in FIG. 12B. For example, the estimation function 21G calculates an average value of the densities of persons 32 with respect to each of the areas P in other target images 30 shot at the same shooting locations as that of the target image 30 being the processing target and at shooting timings prior to shooting (in the past of) the target image 30. The estimation function 21G then generates the reference image 37 in which the average value of the densities of persons 32 with respect to each of areas P′ is defined. The estimation function 21G thus acquires the reference image 37 (see FIG. 12B).

The areas P′ in the reference image 37 and the areas P in the target image 30 are regions divided under the same division condition. Therefore, the areas P′ in the reference image 37 and the areas P in the target image 30 correspond in a one-to-one relation.

Next, the estimation function 21G specifies a region (a first region 34′ and a surrounding region 35′) in the reference image 37, corresponding to the first region 34 and the surrounding region 35 in the target image 30 being the processing target (see FIG. 12B).

The estimation function 21G calculates a multiplication result (B′×A/A′) by multiplying a density distribution (B′) of the first region 34′ in the reference image 37 by a ratio (A/A′) of a density distribution (A) of the surrounding region 35 in the target image 30 to a density distribution (A′) of the surrounding region 35′ in the reference image 37 as a density distribution (B) of the first region 34 in the target image 30 (B=(B′×A/A′)) (see FIG. 12C).

Specifically, the estimation function 21G multiplies the density in each of the areas P′ included in the first region 34′ of the reference image 37 by the ratio (A/A′) of an average value (A) of the densities in the areas P included in the surrounding region 35 of the target image 30 to an average value (A′) of the densities in the areas P′ included in the surrounding region 35′ of the reference image 37. The estimation function 21G then uses the multiplication result with respect to each of the areas P′ included in the first region 34′ of the reference image 37 as the density in each of the areas P included in the first region 34 of the target image 30. The estimation function 21G thus estimates the density distribution of the first region 34 in the target image 30.

The estimation function 21G can estimate the density distribution of the first region 34 in the target image 30 using a function representing a regression plane or a regression curve that approximates a distribution of ratios of the densities of persons 32 in the areas P of the target image 30 to the densities in the corresponding areas P′ of the reference image 37.

In this case, the estimation function 21G generates a function using a ratio of the density of persons 32 in each of the areas P included in the surrounding region 35 of the target image 30 to the density of persons 32 in the corresponding area P′ included in the surrounding region 35′ of the reference image 37. This function is a function representing a regression plane or a regression curve that approximates a distribution of ratios of the densities in the entire reference image 37. The estimation function 21G then generates a map indicating the distribution of the ratios of the densities in the entire reference image 37 (the ratios of the densities in the respective areas P′ in the reference image 37) using the generated function.

Furthermore, the estimation function 21G multiplies the density in each of the areas P′ included in the first region 34′ of the reference image 37 by the ratio of the densities in each of the corresponding areas P′ included in the first region 34′ in the generated map to obtain a multiplication result. The estimation function 21G then uses the multiplication result in each of the areas P′ included in the first region 34′ as the density in each of the corresponding areas P included in the first region 34 of the target image 30. In this way, the estimation function 21G estimates the density in each of the areas P of the first region 34 in the target image 30. That is, the estimation function 21G estimates the density distribution of the first region 34 in the target image 30.

The estimation function 21G can estimate the density distribution of the first region 34 in the target image 30 using a function representing a regression plane or a regression curve that approximates a distribution of ratios to the densities of persons 32 in areas P′ in the reference image 37, in which a dispersion value is equal to or lower than a threshold value, of the densities of persons 32 in the corresponding areas P in the target image 30.

The dispersion value is a value indicating the degree of dispersion of the densities according to the shooting scene (the shooting timing (the shooting hour, the shooting period (the season), or the like)) of the reference image 37. It is sufficient that the estimation function 21G defines the dispersion value for each of the areas P at the time of calculation of the reference image 37. Accordingly, in this case, it is sufficient that the estimation function 21G uses the reference image 37 in which the average density and the dispersion value are defined for each of the areas P′.

In detail, in this case, the estimation function 21G specifies areas P′ in which the dispersion value is equal to or lower than the threshold (the degree of dispersion is small) among the areas P′ included in the surrounding region 35′ of the reference image 37. It is sufficient that the estimation function 21G uses the ratio to the density of persons 32 in each of the specified areas P′, of the density of persons 32 in each of the corresponding areas P included in the surrounding region 35 of the target image 30 to generate a function representing a regression plane or a regression curve that approximates the distribution of the ratios of the densities in the entire reference image 37. The estimation function 21G then generates a map indicating the distribution of the ratios of the densities in the entire reference image 37 (the ratios of the densities in the respective areas P′ in the reference image 37) by using the generated function.

Furthermore, the estimation function 21G multiplies the density of persons 32 in each of the areas P′ included in the first region 34′ of the reference image 37 by the ratio of the density in each of the corresponding areas P included in the first region 34 in the map to obtain a multiplication result. The estimation function 21G then uses the multiplication result of each of the areas P′ included in the first region 34′ as the density in each of the corresponding areas P included in the first region 34 of the target image 30.

In this way, the estimation function 21G estimates the density in each of the areas P included in the first region 34 of the target image 30. That is, the estimation function 21G estimates the density distribution of the first region 34 in the target image 30.

A procedure of image processing performed by the image processing apparatus 21 of the second embodiment is described next.

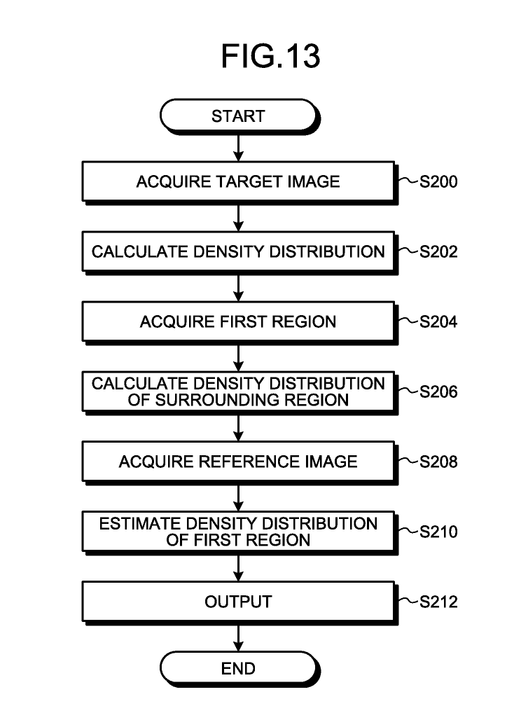

FIG. 13 is a flowchart illustrating an example of the procedure of the image processing performed by the image processing apparatus 21 of the second embodiment.

First, the image acquisition function 20D acquires a target image 30 being a detection target of a first region 34 (Step S200). Next, the calculation function 20E calculates a density distribution of persons 32 in the target image 30 acquired at Step S200 (Step S202). In the second embodiment, the calculation function 20E calculates a density distribution 31 by dividing the target image 30 acquired at Step S200 into a plurality of areas P and calculating the density of persons 32 included in each of the divided areas P.

Subsequently, the region acquisition function 20F acquires the first region 34 of the target image 30 (Step S204). Next, the estimation function 21G calculates a density distribution of persons 32 in a surrounding region 35 around the first region 34 acquired at Step S204 in the target image 30 acquired at Step S200 (Step S206).

Subsequently, the estimation function 21G acquires a reference image 37 (Step S208). Next, the estimation function 21G estimates a density distribution of persons 32 in the first region 34 acquired at Step S204 in the target image 30 acquired at Step S200 using the reference image 37 acquired at Step S208 (Step S210). The output control function 20H outputs the estimation result obtained at Step S210 (Step S212). The present routine then ends.

As described above, in the image processing apparatus 21 of the second embodiment, the estimation function 21G estimates the density distribution of the first region 34 in the target image 30 based on the density distribution of the surrounding region 35 in the target image 30 and the density distributions of the first region 34′ and the surrounding region 35′ in the reference image 37.

Such a use of the reference image 37 enables the image processing apparatus 21 of the second embodiment to estimate the density distribution of targets (persons 32) in a specific region in an image more accurately, as well as to provide the effects of the first embodiment.

### Third Embodiment

In a third embodiment, the density distribution of the first region 34 is estimated by a method different from that in the first embodiment.

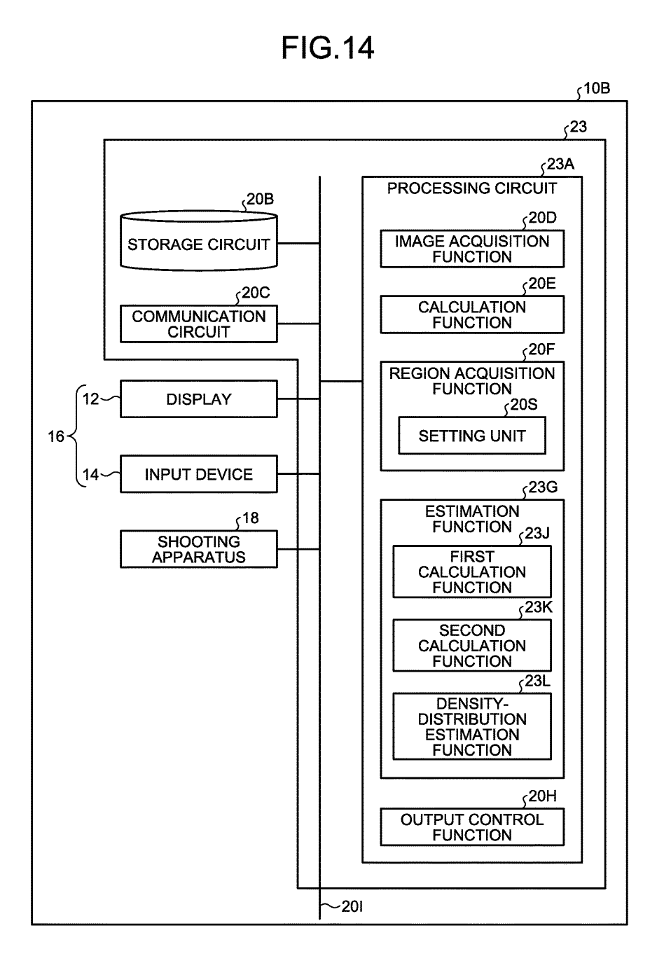

FIG. 14 is a block diagram illustrating a functional configuration of an image processing system 10B of the third embodiment.

The image processing system 10B includes the UI 16, the shooting apparatus 18, and an image processing apparatus 23. The UI 16 and the shooting apparatus 18 are connected to the image processing apparatus 23 via the bus 201. The image processing system 10B is identical to the image processing system 10 of the first embodiment except that the image processing apparatus 23 is provided instead of the image processing apparatus 20.

The image processing apparatus 23 is, for example, a dedicated or general-purpose computer. The image processing apparatus 23 is, for example, a PC (personal computer) connected to the shooting apparatus 18, a server that retains and manages images, or a cloud server that performs processing on a cloud.

The image processing apparatus 23 has a processing circuit 23A, the storage circuit 20B, and the communication circuit 20C. The image processing apparatus 23 is identical to the image processing apparatus 20 of the first embodiment except that the processing circuit 23A is provided instead of the processing circuit 20A.

The processing circuit 23A has the image acquisition function 20D, the calculation function 20E, the region acquisition function 20F, an estimation function 23G, and the output control function 20H. In FIG. 14, functions related to the third embodiment are mainly illustrated. However, functions included in the processing circuit 23A are not limited thereto.

The processing circuit 23A is identical to the processing circuit 20A of the first embodiment except that the estimation function 23G is provided instead of the estimation function 20G.

The estimation function 23G is an example of the estimation unit. The estimation function 23G estimates the density distribution of the first region 34 in the target image 30 based on moving directions of persons 32 in a surrounding region 35′ of a reference image and moving directions of persons 32 in the surrounding region 35 of the target image 30.

In the third embodiment, the reference image is other target image 30 shot in a shooting scene corresponding to the target image 30 being a processing target. In detail, in the third embodiment, the target image 30 being the processing target and the reference image are the same in at least one of the shooting location (the shooting angle of view), and the contents of an event held at the shooting location during shooting and are different in the shooting timing.

Specifically, in the third embodiment, a case where the reference image is an image obtained by shooting the same shooting location with the same shooting apparatus 18 as that of the target image 30 being the processing target in a different shooting timing is described. More specifically, in the third embodiment, the reference image is other target image 30 obtained by shooting the same shooting location with the same shooting apparatus 18 as that of the target image 30 being the processing target prior to shooting (in the past of) the target image 30 being the processing target.

In the third embodiment, the estimation function 23G estimates the density distribution of persons 32 in the first region 34 of the target image 30 using the reference image described above.

In the third embodiment, the estimation function 23G estimates the density distribution of the persons 32 in the first region 34 of the target image 30 using also the moving directions of the persons 32.

Specifically, the estimation function 23G has a first calculation function 23J, a second calculation function 23K, and a density-distribution estimation function 23L.

The first calculation function 23J is an example of a first calculation unit. The second calculation function 23K is an example of a second calculation unit. The density-distribution estimation function 23L is an example of a density-distribution estimation unit.

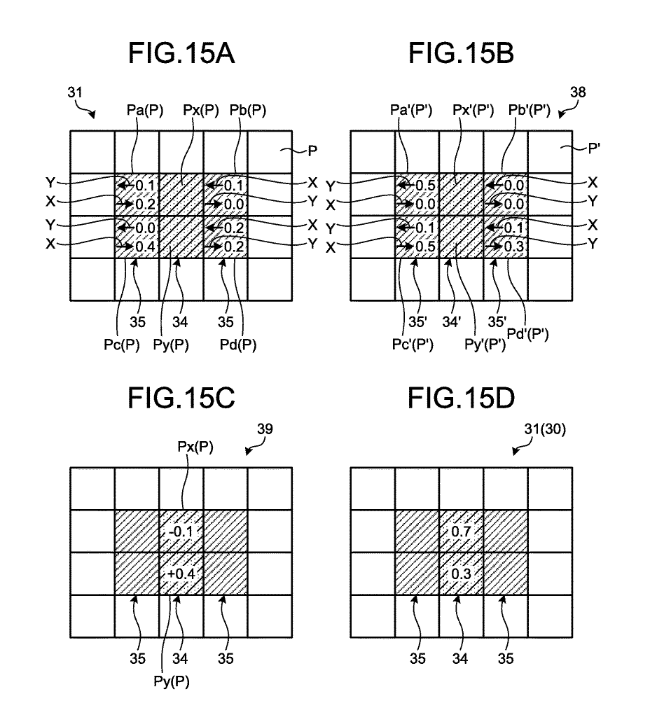

FIGS. 15A to 15D are explanatory diagrams of estimation of a density distribution of the first region 34, performed by the estimation function 23G.

For example, it is assumed that the calculation function 20E calculates the density distribution 31 by calculating the density of persons 32 in each of the areas P in the target image 30. It is also assumed that the region acquisition function 20F then sets the first region 34 in the target image 30 and the surrounding region 35 around the first region 34. In the example illustrated in FIG. 15A, the first region 34 of the target image 30 includes an area Px and an area Py. The surrounding region 35 of the target image 30 includes areas Pa to Pd.

The first calculation function 23J calculates the density of persons 32 moving in an entering direction X from the surrounding region 35 to the first region 34 and the density of persons 32 moving in an exiting direction Y from the first region 34 to the surrounding region 35, in the surrounding region 35 of the target image 30.

The first calculation function 23J calculates the density of persons 32 moving in the entering direction X and the density of persons 32 moving in the exiting direction Y with respect to each of the areas P (the areas Pa to Pd in FIG. 15) included in the surrounding region 35.

First, the first calculation function 23J determines the positions of persons 32 included in each of the areas P included in the surrounding region 35. It is sufficient to use a known image analysis to determine the positions of the persons 32. The first calculation function 23J determines the positions of corresponding persons 32 in other target image 30 shot at the same shooting location prior to shooting (in the past of) the target image 30 being the processing target.

The first calculation function 23J then determines the moving directions of the positions of the corresponding persons 32 between the target image 30 being the processing target and the other target image 30. It is sufficient to use a known method to determine the moving directions. For example, it is sufficient that the first calculation function 23J determines the moving directions of the persons 32 using a known method such as an optical flow method.

In this way, the first calculation function 23J determines whether the moving directions of the persons 32 included in the surrounding region 35 in the target image 30 being the processing target are the entering direction X or the exiting direction Y.

The first calculation function 23J further calculates the number of persons 32 moving in the entering direction X and the number of persons 32 moving in the exiting direction Y with respect to each of the areas P in the surrounding region 35. The first calculation function 23J calculates the density of persons 32 moving in the entering direction X and the density of persons 32 moving in the exiting direction Y with respect to each of the areas P of the surrounding region 35 using the area (“1” in this example) of each of the areas P (see FIG. 15A).

It is sufficient that the first calculation function 23J calculates the density of persons 32 moving in the exiting direction Y and the density of persons 32 in the entering direction X with respect to each of the areas P in the surrounding region 35, and the calculation method is not limited. It is thus sufficient that the first calculation function 23J calculates the density of persons 32 moving in each of the exiting direction Y and the entering direction X with respect to each of the areas P by other methods, without using the method of calculating the moving direction of each of the persons 32.

Next, the second calculation function 23K acquires a reference image 38 corresponding to the target image 30 being the processing target (see FIG. 15B). Definition of the reference image 38 of the third embodiment is as described above. The second calculation function 23K then determines regions (a first region 34′ and a surrounding region 35′) in the reference image 38, corresponding to the first region 34 and the surrounding region 35 in the target image 30 being the processing target.

The second calculation function 23K calculates the density of persons 32 moving in the entering direction X and the density of persons 32 moving in the exiting direction Y in the surrounding region 35′ of the reference image 38 with respect to each of areas P′. It is sufficient that the second calculation function 23K calculates the density of persons 32 moving in the entering direction X and the density of persons 32 moving in the exiting direction Y with respect to each of the areas P′ (areas Pa′ to Pd′) included in the surrounding region 35′ of the reference image 38 similarly to the first calculation function 23J.

The density-distribution estimation function 23L estimates the density distribution of persons 32 in the surrounding region 35 of the target image 30 based on a density change value of the persons 32 in the surrounding region 35′ of the reference image 38 and a density change value of the persons 32 in the surrounding region 35 of the target image 30.

A density change value is a value obtained by subtracting the density of persons 32 moving in a direction (the exiting direction Y) from the first region 34 (or the first region 34′) to the surrounding region 35 (or the surrounding region 35′) from the density of persons 32 moving in a direction (the entering direction X) from the surrounding region 35 (or the surrounding region 35′) to the first region 34 (or the first region 34′).

In detail, the density-distribution estimation function 23L subtracts the number of persons 32 moving in the direction (the exiting direction Y) from the first region 34 (or the first region 34′) to the surrounding region 35 (or the surrounding region 35′) from the number of persons 32 moving in the direction (the entering direction X) from the surrounding region 35 (or the surrounding region 35′) to the first region 34 (or the first region 34′). The density-distribution estimation function 23L then calculates the density of persons 32 moving in the entering direction X and the density of persons 32 moving in the exiting direction Y using the subtraction result and the area (“1” in this example) of each of the areas P (the areas P′).

For example, the density-distribution estimation function 23L uses a subtraction value obtained by subtracting the density of persons 32 moving in the exiting direction Y in the surrounding region 35 of the target image 30 from the density of persons 32 moving in the entering direction X in the surrounding region 35′ of the reference image 38 as the density change value. The density-distribution estimation function 23L then estimates the density distribution of the persons 32 in the surrounding region 35 of the target image 30 based on the density change value.

Specifically, with respect to each of the areas P included in the surrounding region 35 of the target image 30, the density-distribution estimation function 23L calculates the density change value by subtracting the density of persons 32 moving in the exiting direction Y in the relevant area P in the surrounding region 35 of the target image 30 from the density of persons 32 moving in the entering direction X in the corresponding area P′ in the surrounding region 35′ of the reference image 38.

In the case of the example illustrated in FIG. 15, with respect to the area Pa in the target image 30, the density-distribution estimation function 23L calculates a density change value “−0.1” by subtracting the density “0.1” of persons 32 moving in the exiting direction Y in the area Pa of the target image 30 from the density “0.0” of persons 32 moving in the entering direction X in the area Pa′ of the reference image 38.

Similarly, with respect to each of the remaining areas P (the areas Pb to Pd) in the surrounding region 35 of the target image 30, the density-distribution estimation function 23L calculates the density change values “0”, “0.5”, and “−0.1” in a similar manner.

The density-distribution estimation function 23L then calculates a total value of the density change values of respective areas P in the surrounding region 35 adjacent to each of the areas P of the first region 34 in the target image 30 as the density change value of the persons 32 in each of the areas P in the first region 34.

Specifically, with respect to the area Px of the first region 34, the density-distribution estimation function 23L calculates a total value (“−0.1”) of the density change values (“−0.1” and “0”) of the area Pa and the area Pb adjacent to the area Px as the density change value of the area Px (see FIG. 15C).

Similarly, with respect to the area Py of the first region 34, the density-distribution estimation function 23L calculates a total value (“0.4”) of the density change values (“0.5” and “−0.1”) of the area Pc and the area Pd adjacent to the area Py as the density change value of the area Py (see FIG. 15C).

The density-distribution estimation function 23L then adds the calculated density change value to an initial density of each of the areas P (the areas Px and Py) of the first region 34 in the target image 30. It is sufficient that the density of persons 32 in a region corresponding to the first region 34 in one of other target images 30 that have been shot in the past at the same shooting location as that of the target image 30 being the processing target, where images of persons 32 are taken in the region corresponding to the first region 34 is used as the initial value.

For example, the density-distribution estimation function 23L adds the density change value (“−0.1”) of the area Px in the first region 34 to the initial density (“0.8”, for example) of the area Px. The density-distribution estimation function 23L then uses a value (“0.7”) obtained by this addition as the density of the area Px.

Similarly, the density-distribution estimation function 23L adds the density change value (“0.4”) of the area Py in the first region 34 to the initial density (“0.1”, for example) of the area Py. The density-distribution estimation function 23L uses a value (“0.5”) obtained by this addition as the density of the area Py.

With this processing, the density-distribution estimation function 23L calculates the density of each of the areas P in the first region 34 of the target image 30.

Alternatively, the density-distribution estimation function 23L can regard the density of persons 32 in a shot image being a reference as the initial density and can calculate the density of each of the areas P in the first region 34 of the target image 30 being the processing target using a value obtained by adding a density change value of persons 32 in a target image 30 shot after shooting the reference shot image to the initial density with respect to each of the areas P.

When a target image 30 in which there are no persons 32 in a region other than the first region 34 is shot by the shooting apparatus 18, it is sufficient that the density-distribution estimation function 23L uses this target image 30 as a reference shot image to reset the initial density to (“0.0”).

The density-distribution estimation function 23L can use other target image 30 in which images of persons 32 are taken in the first region 34 of the target image 30 being the processing target as the reference shot image.

The density-distribution estimation function 23L can use a subtraction value obtained by subtracting the density of persons 32 moving in the exiting direction Y in the surrounding region 35′ of the reference image 38 from the density of persons 32 moving in the entering direction X in the surrounding region 35 of the target image 30 as the density change value. It is sufficient that the density-distribution estimation function 23L calculates the subtraction value with respect to each of the corresponding areas (the areas P and the areas P′) in the target image 30 and the reference image 38 in the same manner as described above.

The density-distribution estimation function 23L can use a subtraction value obtained by subtracting the density of persons 32 moving in the exiting direction Y in the surrounding region 35 of the target image 30 from the density of persons 32 moving in the entering direction X in the surrounding region 35 as the density change value. It is sufficient that the density-distribution estimation function 23L calculates the subtraction value with respect to each of the areas P in the target image 30.

The density-distribution estimation function 23L can estimate the density distribution of the first region 34 in the target image 30 using moving speeds of persons 32 in addition to the moving directions of persons 32. That is, the density-distribution estimation function 23L can estimate the density distribution of the persons 32 in the first region 34 of the target image 30 using the density change value of the persons 32 and the moving speeds of the persons 32.

In this case, the first calculation function 23J calculates the density and the moving speeds of persons 32 moving in the entering direction X and the density and the moving speeds of persons 32 moving in the exiting direction Y in the surrounding region 35 of the target image 30.

It is sufficient that the moving speed of a person 32 is obtained using a known method. For example, it is sufficient that the moving speed of a person 32 is calculated using the position of the person 32 in other target image 30 shot in the past, the position of the corresponding person 32 in the target image 30 being the processing target, and a difference in the shooting timing.

The second calculation function 23K calculates the density and the moving speeds of persons 32 moving in the entering direction X and the density and the moving speeds of persons 32 moving in the exiting direction Y in the surrounding region 35′ of the reference image 38. It is sufficient that the second calculation function 23K calculates the moving speeds of persons 32 similarly to the first calculation function 23J.

Furthermore, in the same manner as described above, the density-distribution estimation function 23L calculates a density change value by subtracting the density of persons 32 moving in the exiting direction Y in the surrounding region 35′ of the reference image 38 from the density of persons 32 moving in the entering direction X in the surrounding region 35 of the target image 30. The density-distribution estimation function 23L then calculates a density change value with respect to each of the areas P included in the first region 34 of the target image 30 in the same manner as described above. The density-distribution estimation function 23L estimates the density of the persons 32 with respect to each of the areas P included in the first region 34 in the same manner as described above.

Furthermore, with respect to each of the persons 32 included in the surrounding region 35 of the target image 30, the density-distribution estimation function 23L estimates the position (estimated position) of the moved person 32 in the first region 34 of the target image 30 using the calculated moving speed.

The density-distribution estimation function 23L allocates in a distributed manner, to each of the estimated positions of the moved persons 32 in the first region 34 of the target image 30, the density corresponding the relevant area P including the estimated position.

Specifically, it is assumed that the density of persons 32 entering the first region 34 (moving in the entering direction X) at a moving speed of 0.5 m/s is 0.3 (persons) and the density of persons 32 entering the first region 34 at a moving speed of 1.0 m/s is 0.4 (persons) in the surrounding region 35 of the target image 30. In this case, the density change value in the first region 34 is “+0.7” (persons). In this case, the density-distribution estimation function 23L estimates the density distribution in the first region 34 in such a manner that there are 0.3 persons at a position in the first region 34, which the persons enter from the surrounding region 35 to the first region 34 at the moving speed of 0.5 m/s (a position obtained by multiplying an elapsed time) and there are 0.4 persons at a position which the persons enter at the moving speed of 1.0 m/s.

By thus estimating the density distribution in the first region 34 of the target image 30 using the moving speeds of the persons 32 in addition to the moving directions of the persons 32, the density-distribution estimation function 23L can estimate a more detailed density distribution in the first region 34 than in a case of not using the moving speeds.

A procedure of image processing performed by the image processing apparatus 23 of the third embodiment is described next.

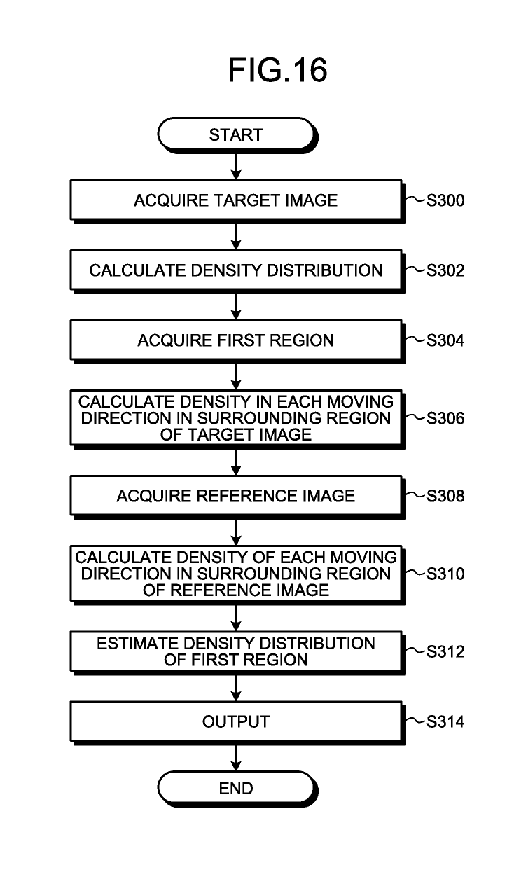

FIG. 16 is a flowchart illustrating an example of the procedure of the image processing performed by the image processing apparatus 23 of the third embodiment.

First, the image acquisition function 20D acquires a target image 30 being a detection target for a first region 34 (Step S300). Next, the calculation function 20E calculates the density distribution of persons 32 in the target image 30 acquired at Step S300 (Step S302).

Subsequently, the region acquisition function 20F acquires the first region 34 in the target image 30 (Step S304).

Next, the first calculation function 23J of the estimation function 23G calculates the density of persons 32 moving in the entering direction X from the surrounding region 35 to the first region 34 and the density of persons 32 moving in the exiting direction Y from the first region 34 to the surrounding region 35, in the surrounding region 35 of the target image 30 acquired at Step S300 (Step S306).

Subsequently, the second calculation function 23K acquires a reference image 38 (Step S308). As described above, for example, the second calculation function 23K acquires other target image 30 shot at the same shooting location as that of the target image 30 acquired at Step S300 and at a different shooting time (past shooting time, for example) from that of the target image 30 as the reference image 38.

Next, the second calculation function 23K calculates the density of persons 32 moving in the entering direction X from the surrounding region 35′ to the first region 34′ and the density of persons 32 moving in the exiting direction Y from the first region 34′ to the surrounding region 35′ in the surrounding region 35′ of the reference image 38 acquired at Step S308 (Step S310).

Subsequently, the density-distribution estimation function 23L estimates the density distribution of the persons 32 in the first region 34 acquired at Step S304 in the target image 30 acquired at Step S300 using the calculation result obtained at Step S306 and the calculation result obtained at Step S310 (Step S312).

Next, the output control function 20H outputs the estimation result obtained at Step S312 (Step S314). The present routine then ends.

As described above, in the image processing apparatus 23 of the third embodiment, the estimation function 23G estimates the density distribution of the first region 34 in the target image 30 using also the moving directions of the persons 32.

The image processing apparatus 23 of the third embodiment thus can estimate the density distribution of the persons 32 in the first region 34 of the target image 30 more accurately as well as providing the effects of the first embodiment.

That is, even when the first region 34 is a region shielded by an immobile object such as a post fixed to the ground, the estimation function 23G estimates the density distribution using also the moving directions of persons 32, so that the density distribution of the first region 34 can be estimated more accurately.

The image processing apparatuses 20, 21, and 23 of the embodiments described above are applicable to various apparatuses that detect persons 32 included in a target image 30. For example, the image processing apparatuses 20, 21, and 23 of the embodiments described above are applicable to a monitoring apparatus that monitors a specific monitoring region. In this case, it is sufficient to place the shooting apparatus 18 at a position where a monitoring region being a monitoring target can be shot. It is sufficient to then estimate the density distribution of the persons 32 in the first region 34 described above using the target image 30 being the monitoring target shot by the shooting apparatus 18.

The image processing apparatuses 20, 21, and 23 of the embodiments described above are also applicable to a smart-community monitoring system, a plant monitoring system, a medical abnormal-position detection system, or the like, and the applicable range thereof is not limited.

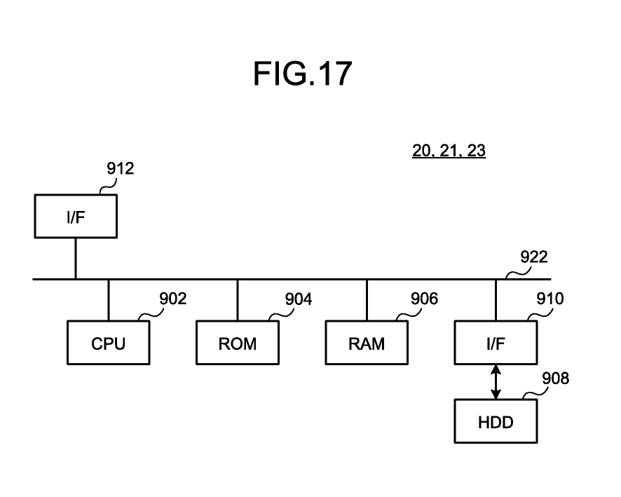

A hardware configuration of the image processing apparatuses 20, 21, and 23 of the embodiments described above is described next. FIG. 17 is a block diagram illustrating a hardware configuration of the image processing apparatuses 20, 21, and 23 of the embodiments described above. The image processing apparatuses 20, 21, and 23 of the embodiments described above include a CPU 902, a RAM 906, a ROM 904 that has programs and the like stored therein, a HDD 908, an I/F 910 being an interface with the HDD 908, an I/F 912 being an interface for image input, and a bus 922, which is a hardware configuration using a general computer. The CPU 902, the ROM 904, the RAM 906, the I/F 910, and the I/F 912 are connected to one another via the bus 922.

In the image processing apparatuses 20, 21, and 23 of the embodiments described above, the CPU 902 reads a program from the ROM 904 onto the RAM 906 and executes the read program, so that the units described above are realized on the computer.

The program for performing the respective processes described above, being executed in the image processing apparatuses 20, 21, and 23 according to the embodiments described above, can be stored in the HDD 908. The program for performing the processes described above, being executed in the image processing apparatuses 20, 21, and 23 according to the embodiments described above, can be incorporated in the ROM 904 in advance and provided.

Further, the program for performing the processes described above, being executed in the image processing apparatuses 20, 21, and 23 according to the embodiments described above, can be provided as a computer program product while being stored in a computer-readable recording medium such as a CD-ROM, a CD-R, a memory card, a DVD (Digital Versatile Disk), a flexible disk (FD), as a file of an installable format or an executable format.

Besides, the program for performing the processes described above, being executed in the image processing apparatuses 20, 21, and 23 according to the embodiments described above, can be stored in a computer connected to a network such as the Internet, and then downloaded via the network to be provided. Further, the program for performing the processes described above, being executed in the image processing apparatuses 20, 21, and 23 according to the embodiments described above, can be provided or distributed via a network such as the Internet.

For example, each step in the flowcharts of the embodiments described above can be performed while changing the execution order thereof, performed simultaneously in plural, or performed in a different order at each execution, unless contrary to the nature thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a memory; and
processing circuitry configured to operate as:
an image acquisition unit that acquires a target image;
a calculation unit that calculates a density distribution of targets included in the target image;
and
an estimation unit that estimates the density distribution in a first region in the target image based on the density distribution in a surrounding region of the first region in the target image.

2. The image processing apparatus according to claim 1, wherein the estimation unit estimates the density distribution in the first region by performing polynomial interpolation of the density distribution in the surrounding region in the target image.

3. The image processing apparatus according to claim 1, wherein the estimation unit estimates the density distribution in the first region using an average value of densities represented by the density distribution in the surrounding region in the target image.

4. The image processing apparatus according to claim 1, wherein the estimation unit estimates a density distribution in the first region in the target image from the density distribution in the surrounding region in the target image using a function representing a regression plane or a regression curve that approximates a density distribution in the target image based on densities in areas included in the surrounding region in the target image.

5. The image processing apparatus according to claim 1, wherein the estimation unit estimates the density distribution in the first region in the target image based on density distributions in the first region in a reference image and a surrounding region of the first region, and a density distribution in a surrounding region of the first region in the target image.

6. The image processing apparatus according to claim 5, wherein the reference image is an average-density distribution image in which average values of densities of the targets in a plurality of the target images are defined.

7. The image processing apparatus according to claim 5, wherein the estimation unit calculates a multiplication result by multiplying a density distribution of the first region in the reference image by a ratio of the density distribution of the surrounding region in the target image to the density distribution of the surrounding region in the reference image, as a density distribution of the first region in the target image.

8. The image processing apparatus according to claim 5, wherein the estimation unit estimates the density distribution of the first region in the target image based on a function representing a regression plane or a regression curve that approximates a distribution of ratios of densities of the targets in areas in the target image to densities of the targets in the corresponding areas in the reference image.

9. The image processing apparatus according to claim 8, wherein the estimation unit estimates the density distribution of the first region in the target image based on a function representing a regression plane or a regression curve that approximates a distribution of ratios of densities of the targets in the corresponding areas in the target image to densities of the targets in the areas in the reference image, in which a dispersion value indicating a degree of dispersion of densities according to a shooting scene is equal to or lower than a threshold.

10. The image processing apparatus according to claim 5, wherein the estimation unit estimates the density distribution of the first region in the target image based on density distributions of the first region in the reference image and a surrounding region of the first region corresponding to a shooting scene of the target image, and a density distribution of a surrounding region of the first region in the target image.

11. The image processing apparatus according to claim 1, wherein
the estimation unit includes
a first calculation unit that calculates a density of the targets moving in an entering direction from the surrounding region of the target image to the first region and a density of the targets moving in an exiting direction from the first region to the surrounding region, in the surrounding region of the target image,
a second calculation unit that calculates a density of the targets moving in the entering direction and a density of the targets moving in the exiting direction, in the surrounding region of a reference image, and
a density-distribution estimation unit that estimates a density distribution of the first region in the target image based on a density change value obtained by subtracting a density of the targets moving in the exiting direction in the surrounding region of the target image from a density of the targets moving in the entering direction in the surrounding region of the reference image.

12. The image processing apparatus according to claim 1, wherein
the estimation unit includes
a first calculation unit that calculates a density of the targets moving in an entering direction from the surrounding region of the target image to the first region and a density of the targets moving in an exiting direction from the first region to the surrounding region, in the surrounding region,
a second calculation unit that calculates a density of the targets moving in the entering direction and a density of the targets moving in the exiting direction, in the surrounding region of a reference image, and
a density-distribution estimation unit that estimates a density distribution of the first region in the target image based on a density change value obtained by subtracting a density of the targets moving in the exiting direction in the surrounding region of the reference image from a density of the targets moving in the entering direction in the surrounding region of the target image.

13. The image processing apparatus according to claim 1, wherein
the estimation unit includes
a first calculation unit that calculates a density of the targets moving in an entering direction from the surrounding region of the target image to the first region and a density of the targets moving in an exiting direction from the first region to the surrounding region, in the surrounding region, and
a density-distribution estimation unit that estimates a density distribution of the first region in the target image based on a density change value obtained by subtracting a density of the targets moving in the exiting direction from a density of the target moving in the entering direction, in the surrounding region of the target image.

14. The image processing apparatus according to claim 1, wherein
the estimation unit includes
a first calculation unit that calculates a density and moving speeds of the targets moving in an entering direction and a density and moving speeds of the targets moving in the exiting direction, in an surrounding region of the target image,
a second calculation unit that calculates a density and moving speeds of the targets moving in the entering direction and a density and moving speeds of the targets moving in the exiting direction, in the surrounding region of a reference image, and
a density-distribution estimation unit that estimates a density distribution of the first region in the target image based on a density change value obtained by subtracting a density of the targets moving in the exiting direction in the surrounding region of the reference image from a density of the targets moving in the entering direction in the surrounding region of the target image, and estimation positions of the moved targets estimated from the moving speeds.

15. The image processing apparatus according to claim 1, wherein the region acquisition unit includes a setting unit that sets a predetermined region in the target image as the first region.

16. The image processing apparatus according to claim 1, wherein
the region acquisition unit includes a setting unit, and
the setting unit sets as the first region, a region in the target image, satisfying at least one of having a luminance equal to or lower than a first threshold, having a luminance equal to or higher than a second threshold, having a density equal to or lower than a third threshold among a plurality of areas included in the target image, having a density lower than that of other areas around the relevant area by a fourth threshold or a larger value among the areas, having a density ratio to other peripheral areas equal to or lower than a fifth threshold, having a density equal to or lower than a sixth threshold and a density of the targets moving toward other peripheral areas equal to or higher than a seventh threshold, and having a difference in densities from a corresponding area in another one of the target images shot at different shooting timings, the difference being equal to or larger than an eighth threshold.

17. An image processing method comprising:
acquiring a target image;
calculating a density distribution of targets included in the target image; and
estimating the density distribution of a first region in the target image based on the density distribution of a surrounding region of the first region in the target image.

18. The image processing method according to claim 17, wherein the density distribution in the first region is estimated by performing polynomial interpolation of the density distribution in the surrounding region in the target image.

19. The image processing method according to claim 17, wherein the density distribution in the first region is estimated using an average value of densities represented by the density distribution in the surrounding region in the target image.

20. The image processing method according to claim 17, wherein a density distribution in the first region in the target image is estimated from the density distribution in the surrounding region in the target image using a function representing a regression plane or a regression curve that approximates a density distribution in the target image based on densities in areas included in the surrounding region in the target image.
